(19) United States
(12) Patent Application Publication
(10) Pub. No.: US 2025/0155833 A1
(43) Pub. Date: May 15, 2025

(54) TONER, TWO-COMPONENT DEVELOPER, AND METHOD FOR PRODUCING TONER

(71) Applicant: SHARP KABUSHIKI KAISHA, Sakai City (JP)

(72) Inventor: TADANORI KANO, Sakai City (JP)

(21) Appl. No.: 18/935,468

(22) Filed: Nov. 2, 2024

(30) Foreign Application Priority Data
Nov. 13, 2023 (JP) 2023-192756

(51) Int. Cl. G03G 9/093; G03G 9/08

(52) U.S. Cl. CPC G03G 9/09342; G03G 9/0821; G03G 9/09371; G03G 9/09392

(57) ABSTRACT

A toner including toner particles and an external additive adhering to a surface of the toner particles has the following configuration. The toner particles include a crystalline polyester resin and a wax and have an apparent viscosity at 90° C. in a range from 100000 Pa*s to 200000 Pa*s. The external additive includes a first external additive and a second external additive having an average primary particle size larger than that of the first external additive. A loose bulk density of the toner is in a range from 0.3 g/cm³ to 0.35 g/cm³. When the toner is compressed at 50° C. and 1.2 N/cm², a compression degree of the toner is 50% or less, and a stress relaxation ratio of the toner is 27% or more.

### TECHNICAL FIELD

The disclosure relates to a toner, a two-component developer, and a method for producing the toner.

### BACKGROUND ART

A toner for developing an electrostatic latent image which is utilized in an electrophotographic image forming apparatus such as a copying machine, a multifunction machine, a printer, or a facsimile apparatus generally has a configuration in which an external additive adheres to the surface of toner particles (toner cores).

In recent years, further energy saving is desired in image forming apparatuses, and to realize such energy saving, low-temperature fixability is required for toners. In a low-temperature fixable toner having enhanced low-temperature fixability, the toner particles are formed of a resin that can be fixed at a lower temperature than in known toners.

In a known toner, an external additive adheres to the surface of toner particles having a softening point of 110° C. or less. In the toner, the toner particles include a crystalline polyester resin and a wax. The external additive contains a fine powder and silica particles. The fine powder is produced by subjecting the surface of a composition including strontium titanate and silica to a hydrophobizing treatment using a silane compound. A number average equivalent circular diameter of primary particles of the fine powder is in a range from 20 nm to 50 nm, and a number average equivalent circular diameter of primary particles of the silica particles is in a range from 50 nm to 200 nm.

### SUMMARY

### Technical Problem

In an image forming apparatus operating for a long time, the temperature inside a developer tank is at around 40° C. to 50° C. In such a temperature environment, the external additive is more likely to be embedded into the toner particles in a low-temperature fixable toner than in a normal-temperature environment, even when the level of stress (load) on the toner is substantially the same as that in known toners.

Possible countermeasures for this problem include increasing an addition amount of a small particle size external additive to increase the surface area of the toner particles covered by the external additive, or increasing an addition amount of a medium to a large particle size external additive having a particle size of about 40 nm to 120 nm to enhance a spacer effect. However, when these countermeasures are used, external additives are embedded into the toner particles in the toner in the developer tank shortly after the image forming apparatus starts operating, resulting in problematic charge reduction, and in a high humidity environment, problematic “roughness” or “fogging” of a printing surface occurs.

Note that “roughness” refers to image quality that gives non-uniform and rough impression, and “fogging” refers to a phenomenon in which low charged toner is developed in a non-image area where the toner should not be developed (a phenomenon in which the low charged toner adheres to a photoconductor).

The content of the disclosure has been found in view of such circumstances regarding low-temperature fixable toners, and a main object thereof is to provide a toner, a two-component developer, and a method for producing the toner, by which it is possible to suppress the occurrence of charge reduction and fogging when an image forming apparatus is operated for a long time.

### Solution to Problem

A toner of the disclosure provided to solve the problems described above includes toner particles and an external additive adhering to the surface of the toner particles, and has the following configuration. The toner particles include a crystalline polyester resin and a wax and have an apparent viscosity at 90° C. in a range from 100000 Pa*s to 200000 Pa*s. The external additive includes a first external additive and a second external additive having an average primary particle size larger than that of the first external additive. A loose bulk density of the toner is in a range from 0.3 g/cm³ to 0.35 g/cm³. When the toner is compressed at 50° C. and 1.2 N/cm², a compression degree of the toner is 50% or less, and a stress relaxation ratio of the toner is 27% or more.

In the toner described above, it is preferable that the first external additive includes silica particles, titanium oxide particles, aluminum oxide particles, silica particles including aluminum hydroxide adhering to the surface of the silica particles, or strontium titanate particles to which silica is added, and an average primary particle size of the first external additive is in a range from 10 nm to 35 nm.

In the toner described above, it is preferable that the second external additive includes silica particles and titanium oxide particles, and the silica particles and the titanium oxide particles serving as the second external additive have an average primary particle size in a range from 38 nm to 120 nm.

In the toner described above, it is preferable that a content of the first external additive is in a range from 0.1 parts by mass to 0.5 parts by mass relative to 100 parts by mass of the toner particles, and a content of the second external additive is in a range from 4.0 parts by mass to 6.0 parts by mass relative to 100 parts by mass of the toner particles.

In the toner described above, it is preferable that a strength of adhesion of the first external additive to the toner particles is in a range from 90% to 100%, and a strength of adhesion of the second external additive to the toner particles is in a range from 30% to 50%.

In the toner described above, it is preferable that the toner particles are pulverized toner particles.

A two-component developer of the disclosure provided to solve the problems described above includes the toner and a carrier.

A method for producing the toner of the disclosure provided to solve the problems described above includes a first external addition step of mixing the first external additive and the toner particles to cause the first external additive to adhere to a surface of the toner particles and a second external addition step of mixing the second external additive and the toner particles to cause the second external additive to adhere to a surface of the toner particles, and in the method, the second external addition step is performed after the first external addition step.

### Advantageous Effects of Invention

The toner, the two-component developer, and the method for producing the toner according to the disclosure exhibit excellent effects including suppression of charge reduction and fogging when an image forming apparatus is operated for a long time, without compromising low-temperature fixability.

### BRIEF DESCRIPTION OF DRAWINGS

FIG. 1 is a schematic view illustrating gaps between toner particles when a container is filled with a toner in which a strength of adhesion of a large particle size external additive to the toner particles is low and no load is applied.

FIG. 2 is a schematic view illustrating gaps between toner particles when a container is filled with a toner in which a strength of adhesion of a large particle size external additive to the toner particles is high and no load is applied.

FIG. 3 is a schematic view illustrating gaps between toner particles when a container is filled with a toner in which a large amount of a small particle size external additive adheres to the toner particles and no load is applied.

FIG. 4 is a schematic view illustrating gaps between toner particles when a container is filled with a toner in which a strength of adhesion of a small particle size external additive to the toner particles is low and no load is applied.

FIG. 5 is a schematic view illustrating a movement of toner particles when, after no load is applied, a load is applied to a toner to which a large particle size external additive adheres.

FIG. 6 is a schematic view illustrating a movement of toner particles when, after no load is applied, a load is applied to a toner according to the present embodiment.

FIGS. 7A to 7C are schematic views for explaining that stress in the toner according to the present embodiment, to which a load is applied, is relaxed over time.

FIG. 8 is a graph showing a stress relaxation ratio of a toner of Example 1.

FIG. 9 is a graph showing a stress relaxation ratio of a toner of Comparative Example 1.

FIG. 10 is a graph showing a stress relaxation ratio of a toner of Comparative Example 3.

FIG. 11 is a graph showing a stress relaxation ratio of a toner of Comparative Example 4.

FIG. 12 is a graph showing a stress relaxation ratio of a toner of Comparative Example 5.

FIG. 13 is a graph for explaining a method of measuring the stress relaxation ratio.

### DESCRIPTION OF EMBODIMENTS

A toner and a two-component developer of the disclosure will be described in detail below. First, characteristics of the toner as a whole will be described, and then, materials of the toner will be described.

### 1. Toner

The toner according to the present embodiment is a toner including toner particles and external additives adhering to the surfaces of the toner particles, and satisfies the following requirements (A) to (D).
(A) The toner particles include a crystalline polyester resin and a wax and have an apparent viscosity at 90° C. in a range from 100000 Pa*s to 200000 Pa*s.
(B) The external additives include a first external additive and a second external additive having an average primary particle size larger than that of the first external additive.
(C) The loose bulk density of the toner is in a range from 0.3 g/cm³ to 0.35 g/cm³.
(D) When the toner is compressed at 50° C. and 1.2 N/cm², a compression degree of the toner is 50% or less, and a stress relaxation ratio of the toner is 27% or more.

Regarding the requirement (A), the toner particles according to the present embodiment more preferably have an apparent viscosity at 90° C. in a range from 110000 Pa*s to 150000 Pa*s, from the viewpoint of low-temperature fixability.

Regarding the requirement (C), the loose bulk density of the toner is more preferably in a range from 0.3 g/cm³ to 0.34 g/cm³, and still more preferably in a range from 0.3 g/cm³ to 0.33 g/cm³, from the viewpoint of the mechanism described below.

Regarding the compression degree of the toner in the requirement (D), the compression degree of the toner is more preferably 49% or less, because if the toner has a high compression degree when a heavy load is applied, the mobility of the toner in the mechanism described below is lowered. The lower limit of the compression degree of the toner is preferably 45% or greater, and more preferably 47% or greater.

Regarding the stress relaxation ratio of the toner in the requirement (D), the stress relaxation ratio of the toner is more preferably 30% or greater, from the viewpoint of the mechanism described later.

The reason why the above-described problem can be solved by the toner according to the present embodiment is considered to be as follows.

In an image forming apparatus which is operated for a long time, the temperature inside a developer tank is at around 40° C. to 50° C. In such a temperature environment, the external additive is more easily embedded into the toner particles of a low-temperature fixable toner than in a normal-temperature environment, even when the level of stress (load) on the toner is substantially the same as that on known toners. The load is transmitted by contact between the toner and the carrier or contact between particles of the toner.

In a toner having a low loose bulk density, many gaps (spaces) are present between toner particles. Therefore, when a load is applied, the toner particles move to the gaps, and thus, the internal pressure can be reduced. This reduction in internal pressure can be observed as relaxation of the stress of the toner with respect to the applied load. By utilizing this phenomenon to reduce the contact force between the toner particles, it is possible to obtain a toner having strong stress resistance.

If a larger load is applied to the toner, depending on the state of external addition to the toner particles (the type of the external additive and the state of adhesion of the external additive), the movement of the toner particles is restricted and the stress is not relaxed, resulting in undesirable embedding of the external additive. For this reason, a preferable toner is a toner capable of relaxing the stress by causing slippage on a contact surface between the toner particles to move the toner particles into gaps even under a heavy load.

However, if the contact surface between the toner particles is slippery even before the load is applied to the toner, the toner particles move so as to fill the gaps even when no load is applied to the toner. As a result, the number of gaps between the toner particles becomes insufficient, and the loose bulk density of the toner increases.

In view of the above, it can be said that a toner having an external additive state that can achieve a low bulk density when no load is applied (low loose bulk density) and suitable slipperiness of toner particle surfaces for relaxing stress when a load is applied, can suppress embedding of the external additive into the toner particles when the image forming apparatus is operated for a long time, and thus prevent charge reduction and fogging.

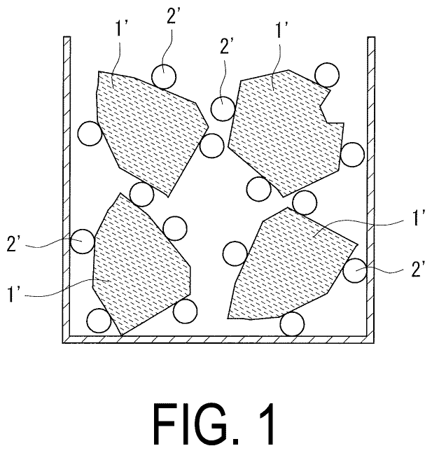

Next, the external additive state that can achieve a low bulk density when no load is applied (low loose bulk density) and suitable slipperiness of toner particle surfaces for relaxing stress when a load is applied, will be described with reference to FIGS. 1 to 6. In the explanation using FIGS. 1 to 6, a model in which a piston is used to apply a load to a toner in a container is described. However, note that, in actual situations, embedding of external additives into toner particles is caused by stress (load) on the developer being conveyed in the developer tank and the temperature environment.

FIGS. 1 to 4 are schematic views each illustrating gaps between toner particles when a container is filled with a toner and no load is applied, and each drawing illustrates a toner in a different state of external addition to the toner particles.

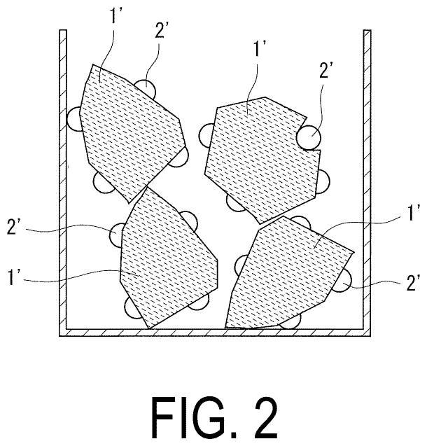

FIG. 1 illustrates the case of a toner in which the strength of adhesion of a large particle size external additive 2′ to toner particles 1′ is low, and in this case, the loose bulk density of the toner is low and many gaps are formed between the toner particles. On the other hand, FIG. 2 illustrates the case of a toner in which the strength of adhesion of the large particle size external additive 2′ to the toner particles 1′ is high. In this case, the spacer effect by the large particle size external additive is weakened, resulting in a high loose bulk density of the toner, and a small number of gaps between the toner particles. A toner having lower loose bulk density has more space which can be used for dispersing a load being applied to the toner (destinations to which the toner particles move). Therefore, a toner can be designed so as to have a low loose bulk density by achieving weak adhesion of the large particle size external additive to the toner particles. Thus, in the toner according to the present embodiment, the strength of adhesion of the second external additive is preferably in the range described below.

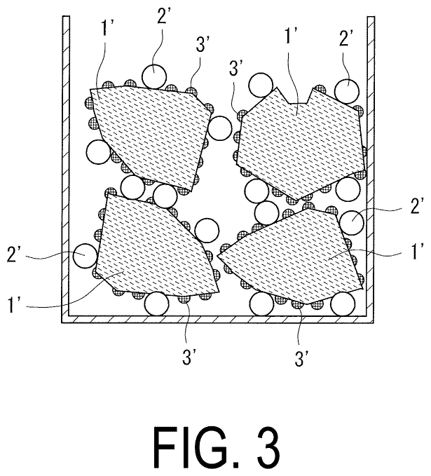

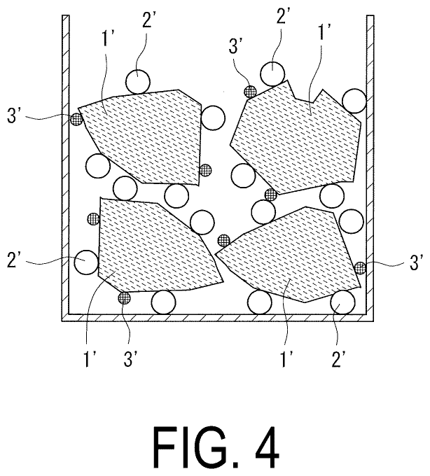

FIG. 3 illustrates the case of a toner in which a large amount of a small particle size external additive 3′ adheres to the toner particles 1′. In this case, the small particle size external additive present in the large amount enhances the mobility of the toner particles, and the toner particles move so as to fill gaps even when no load is applied. Thus, the toner has a high loose bulk density and a small amount of gaps between the toner particles. FIG. 4 illustrates the case of a toner in which the strength of adhesion of the small particle size external additive 3′ to toner particles 1′ is weak. In this case, weak adhesion of the small particle size external additive to toner particles enhances the mobility of the toner particles, and the toner particles move so as to fill gaps even when no load is applied. Thus, the toner has a high loose bulk density and a small amount of gaps between the toner particles. Therefore, a toner can be designed so as to have a low loose bulk density by causing a small amount of the small particle size external additive to strongly adhere to the toner particles. Thus, in the toner according to the present embodiment, the strength of adhesion and the content of the first external additive are preferably in the ranges described below.

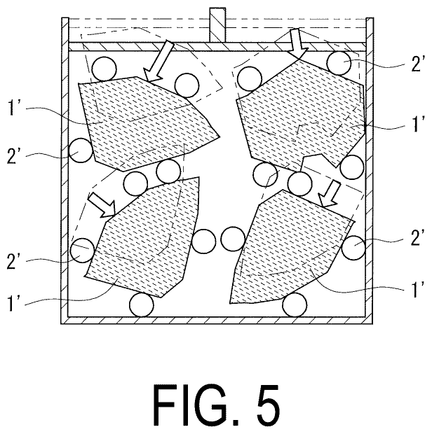

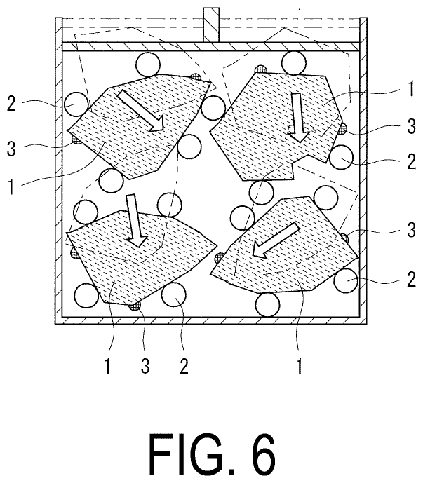

FIGS. 5 and 6 are schematic views illustrating a movement of toner particles when a load is applied to a toner, after no load is applied. When no load is applied, a piston and the toner particles are at positions indicated by broken lines. When the piston is lowered to apply a load, the piston and the toner particles are moved to positions indicated by solid lines. The arrows indicate movement directions of the toner particles.

FIG. 5 illustrates the case of a toner in which the large particle size external additive 2′ adheres to the toner particles 1′. In this case, the toner is in an external addition state in which the loose bulk density is low, and thus, there are many gaps between the toner particles when no load is applied. When a load is applied, the non-slippery surfaces of the toner particles hinder the toner particles from moving to the gaps to disperse the force, and thus, the toner particles stop after a small movement. The toner particles do not move despite gaps left between the toner particles, and thus, a force is exerted on contact points and allows the external additive to be embedded. Therefore, the pressure of the toner in the container is insufficiently dispersed. From a viewpoint of the piston, the stress of the toner with respect to the applied load is not relaxed.

On the other hand, FIG. 6 illustrates the case of the toner according to the present embodiment. In this case, when a load is applied, the toner particles move into the gaps to disperse the force. If the load is further increased, the slippery surfaces of the toner particles do not hinder the movement of the toner particles. As a result, the toner particles move into the gaps further than in the case illustrated in FIG. 5, and thus, no large force is applied to the contact points and the embedding of the external additive is suppressed. Thus, the pressure of the toner in the container is dispersed. From a viewpoint of the piston, the stress of the toner with respect to the applied load is relaxed.

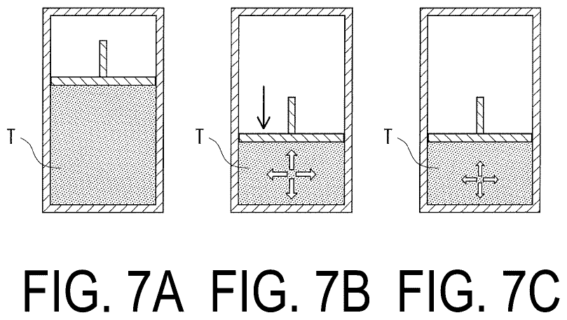

FIGS. 7A to 7C are schematic views for explaining that stress in the toner according to the present embodiment to which a load is applied is relaxed over time. FIG. 7A illustrates a state before a load is applied to the toner in the container. Subsequently, as illustrated in FIG. 7B, the toner in the container is compressed by the piston and then, the height of the piston, that is, the volume of the toner is kept constant, to increase the internal pressure of the container. Immediately after compression, the stress of the toner on the piston is equal to the load. In the toner according to the present embodiment, as described with reference to FIG. 6, the toner particles can move into the gaps. Thus, the force between the toner particles is dispersed, and the internal pressure of the container decreases, as illustrated in FIG. 7C. That is, the stress of the toner on the piston is relaxed with time.

By the above-described mechanism, in the toner according to the present embodiment, even when an image forming apparatus is operated for a long time, it is possible to suppress embedding of the external additive into the toner particles, and thus, prevent charge reduction and fogging.

### 2. Toner Particles (Toner Cores)

The toner particles according to the present embodiment include an internal additive such as a colorant and a binder resin, and the internal additive is dispersed in the binder resin. An external additive adheres to the surfaces of the toner particles. Further, if necessary, an optional component may be included to a degree that does not impair the effects according to the disclosure. The average primary particle size of the toner particles may be appropriately selected depending on the intended purpose and is, for example, in a range from 4.5 m to 8 m.

### 2-1. Binder Resin

The toner particles according to the present embodiment include, as binder resins, at least an amorphous polyester resin and a crystalline polyester resin. By providing the crystalline polyester resin, it is possible to lower the softening temperature and the melt viscosity of the toner. In other words, by using the toner particles in which the amorphous polyester resin and the crystalline polyester resin are used in combination, it is possible to obtain a low-temperature fixable toner having improved low-temperature fixability.

In the disclosure, the amorphous resin and the crystalline resin are distinguished by a crystallinity index. Resins having a crystallinity index in a range from 0.6 to 1.5 are classified as crystalline resins, and resins having a crystallinity index less than 0.6 or greater than 1.5 are classified as amorphous resins. Resins having a crystallinity index greater than 1.5 are amorphous, and resins having a crystallinity index less than 0.6 have low crystallinity and many amorphous parts.

The crystallinity index is an indicator of the degree of crystallinity of the resin and is defined by the ratio of the softening temperature to the maximum endothermic peak temperature (softening temperature/maximum endothermic peak temperature). Here, the maximum endothermic peak temperature refers to the temperature of the peak on the highest temperature side among the endothermic peaks observed. In the crystalline polyester resin, the maximum peak temperature is used as the melting point, and in the amorphous polyester resin, the peak on the highest temperature side is used as the glass transition temperature.

The degree of crystallinity of the resin can be controlled by adjusting the types and ratios of monomers from which the resin is produced, production conditions (e.g., reaction temperature, reaction time, and cooling rate), and the like.

### Amorphous Polyester Resin

The amorphous polyester resin contained in the toner particles according to the present embodiment is obtained by, for example, a polycondensation reaction between a carboxylic acid monomer including terephthalic acid or isophthalic acid as a main component and a polyhydric alcohol including ethylene glycol as a main component.

The dicarboxylic acid monomer used for synthesis of the amorphous polyester resin includes terephthalic acid or isophthalic acid as a main component. The molar content of terephthalic acid or isophthalic acid in the dicarboxylic acid monomer is preferably in a range from 70% to 100%, and more preferably in a range from 80% to 100%.

Furthermore, the dicarboxylic acid monomer may include an aromatic dicarboxylic acid or an aliphatic dicarboxylic acid other than terephthalic acid and isophthalic acid. Examples of the aromatic dicarboxylic acid other than terephthalic acid and isophthalic acid include fumaric acid. Examples of the aliphatic dicarboxylic acid include adipic acid, sebacic acid, and succinic acid. The dicarboxylic acid monomer may include an ester-forming derivative of terephthalic acid or isophthalic acid, an ester-forming derivative of an aromatic dicarboxylic acid other than terephthalic acid and isophthalic acid, an ester-forming derivative of an aliphatic dicarboxylic acid, or the like. In the disclosure, ester-forming derivatives include carboxylic acid anhydrides, alkyl esters, and the like. One of these dicarboxylic acid monomers may be used individually, or two or more may be used in combination.

In the synthesis of the amorphous polyester resin, a polycarboxylic acid monomer containing three or more carboxyl groups may be used together with the dicarboxylic acid monomer described above. As the polycarboxylic acid monomer containing three or more carboxyl groups, a polycarboxylic acid containing three or more carboxyl groups such as trimellitic acid and pyromellitic acid and an ester-forming derivative thereof can be used. One of these polycarboxylic acid monomers containing three or more carboxyl groups may be used individually, or two or more may be used in combination.

The diol monomer used for synthesis of the amorphous polyester resin includes ethylene glycol as a main component. Here, the molar content of ethylene glycol in the diol monomer is preferably in a range from 70% to 100%, and more preferably in a range from 80% to 100%.

The diol monomer may include 1,3-propylene glycol, 1,4-butanediol, and the like. One of these diol monomers may be used individually, or two or more may be used in combination.

The amorphous polyester resin used in the toner according to the present embodiment can be produced in a manner similar to a common polyester production method. For example, the amorphous polyester resin can be synthesized by a polycondensation reaction using a dicarboxylic acid monomer and a polyhydric alcohol, and optionally a polycarboxylic acid monomer containing three or more carboxyl groups, in a temperature range from 190° C. to 240° C. in a nitrogen gas atmosphere. In the polycondensation reaction, the reaction ratio between the diol monomer and the carboxylic acid monomer (including the dicarboxylic acid monomer and, if used, the polycarboxylic acid monomer containing three or more carboxyl groups) is preferably from 1.3:1 to 1:1.2, in terms of [OH]:[COOH] which is the equivalent ratio between the hydroxyl group and the carboxyl group. In the polycondensation reaction, the molar content of the dicarboxylic acid monomer in the carboxylic acid monomer is preferably from 80% to 100%. In the polycondensation reaction, an esterification catalyst such as dibutyltin oxide or titanium alkoxide (for example, tetrabutoxy titanate) may be used if necessary.

The content of the amorphous polyester resin in the toner particles according to the present embodiment is preferably in a range from 40 mass % to 95 mass % and more preferably in a range from 50 mass % to 80 mass %.

### Crystalline Polyester Resin

In the toner particles according to the present embodiment, the crystalline polyester resin is dispersed in the amorphous polyester resin. The crystalline polyester resin is preferably composed of a linear saturated aliphatic polyester unit obtained by polycondensation between a carboxylic acid monomer including an aliphatic dicarboxylic acid having 9 to 22 carbon atoms as a main component and a polyhydric alcohol including an aliphatic diol having 2 to 10 carbon atoms as a main component. The crystalline polyester composed of the linear saturated aliphatic polyester unit lowers the compatibility between the crystalline polyester resin and the amorphous polyester resin.

The dicarboxylic acid monomer used for synthesis of the crystalline polyester resin includes an aliphatic dicarboxylic acid having 9 to 22 carbon atoms as a main component. Here, the molar content of the aliphatic dicarboxylic acid having 9 to 22 carbon atoms in the dicarboxylic acid monomer is preferably in a range from 80% to 100%.

Examples of the aliphatic dicarboxylic acid having 9 to 22 carbon atoms include azelaic acid, sebacic acid, 1,10-decanedicarboxylic acid, and 1,18-octadecanedicarboxylic acid. The dicarboxylic acid monomer may also include an ester-forming derivative of any of these aliphatic dicarboxylic acids. One of these dicarboxylic acid monomers may be used individually, or two or more may be used in combination.

In the synthesis of the crystalline polyester resin, a polycarboxylic acid monomer containing three or more carboxyl groups may be used together with the dicarboxylic acid monomer described above. As the polycarboxylic acid monomer containing three or more carboxyl groups, a polycarboxylic acid containing three or more carboxyl groups such as trimellitic acid and pyromellitic acid and an ester-forming derivative thereof can be used. One of these polycarboxylic acid monomers containing three or more carboxyl groups may be used individually, or two or more may be used in combination.

The diol monomer used for synthesis of the crystalline polyester resin includes an aliphatic diol having 2 to 10 carbon atoms as a main component. Here, the molar content of the aliphatic diol having 2 to 10 carbon atoms in the diol monomer is preferably in a range from 80% to 100%.

Examples of the aliphatic diol having 2 to 10 carbon atoms include ethylene glycol, 1,4-butanediol, and 1,6-hexanediol. One of these diol monomers may be used individually, or two or more may be used in combination.

In the synthesis of the crystalline polyester resin, a polyol monomer containing three or more hydroxyl groups may be used together with the diol monomer. As the polyol monomer containing three or more hydroxyl groups, glycerol, trimethylolpropane, and the like can be used. One of these polyol monomers containing three or more hydroxyl groups may be used individually, or two or more may be used in combination.

The crystalline polyester resin used in the toner according to the present embodiment can be produced in a manner similar to a common polyester production method. For example, the crystalline polyester resin can be synthesized by a polycondensation reaction using a dicarboxylic acid monomer and a diol monomer, and optionally a polycarboxylic acid monomer containing three or more carboxyl groups or a polyol monomer containing three or more hydroxyl groups, in a temperature range from 190° C. to 240° C. in a nitrogen gas atmosphere.

In the above-described polycondensation reaction, the equivalent ratio of the hydroxyl group of the polyol monomer (including the diol monomer and optionally the polyol monomer containing three or more hydroxyl groups) to the carboxyl group of the carboxylic acid monomer (including the dicarboxylic acid monomer and optionally the polycarboxylic acid monomer containing three or more carboxyl groups) (OH group/COOH group) is preferably in a range from 0.83 to 1.3, from the viewpoint of storage stability and the like.

In the above-described polycondensation reaction, the molar content of the dicarboxylic acid monomer in the carboxylic acid monomer is preferably from 90% to 100%. Lower molar content of the dicarboxylic acid monomer results in decrease in the level or rate of crystallization, and insufficient toner aggregation resistance (a tendency of the toner to resist aggregating).

Furthermore, in the polycondensation reaction, the molar content of the diol monomer in the polyol monomer is preferably in a range from 80% to 100%. In the polycondensation reaction, an esterification catalyst such as dibutyltin oxide or titanium alkoxide (for example, tetrabutoxy titanate) may be used if necessary.

The content of the crystalline polyester resin in the toner particles according to the present embodiment is preferably in a range from 5 mass % to 50 mass % and more preferably in a range from 10 mass % to 30 mass %.

### 2-2. Release Agent

The toner particles according to the present embodiment contain a wax as a release agent. The wax is preferably an ester wax, and T1-T2 is preferably in a range from 15° C. to 30° C., where T1 is the temperature of the endothermic peak of the ester wax during heating, T2 is the temperature of the exothermic peak of the ester wax during cooling, and T1 and T2 are measured by using a differential scanning calorimeter. A more preferable range of T1-T2 is from 17° C. to 23° C. An ester wax in which T1-T2 satisfies any of these conditions exhibits a high internal slip effect (an effect of enhancing the compatibility of materials during melt-kneading).

By blending the wax into the toner particles, local charge-up can be suppressed even in a low-humidity environment, and the external additive can be prevented from being embedded into the toner particles throughout the life (product life). That is, it is possible to realize a toner having excellent charge stability with respect to environmental changes and excellent charge stability throughout the life.

Examples of the ester wax include ester wax by the trade names of WE-14, WE-15, and WEP-5, manufactured by NOF CORPORATION.

The content of the wax in the toner particles according to the present embodiment is preferably in a range from 0.5 mass % to 8 mass %, and more preferably in a range from 2 mass % to 7 mass %.

### 2-3. Colorant

The toner particles according to the present embodiment may include a colorant. The colorant is not particularly limited, and organic dyes, organic pigments, inorganic dyes, inorganic pigments, and the like used in the field of electrophotography can be used.

Examples of a black colorant include carbon black, copper oxide, manganese dioxide, aniline black, activated carbon, nonmagnetic ferrite, magnetic ferrite, and magnetite.

Examples of a yellow colorant include C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, and C.I. Pigment Yellow 185.

Examples of a magenta colorant include C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of a cyan colorant include C.I. Pigment Blue 15, C.I. Pigment Blue 15:2, C.I. Pigment Blue 15:3, C.I. Pigment Blue 16, and C.I. Pigment Blue 60.

In the toner according to the present embodiment, the content of the colorant is not particularly limited. However, the content of the colorant is preferably in a range from 4 mass % to 10 mass % in the toner particles. One of the colorants may be used individually, or two or more may be used in combination. To uniformly disperse the colorant in the binder resin, the colorant may be used in the form of a masterbatch.

### 2-4. Charge Control Agent

The toner particles according to the present embodiment may include a charge control agent. The charge control agent is added to impart a preferable charging property to the toner. The charge control agent is not particularly limited, and charge control agents for positive charge control and negative charge control used in the field of electrophotography can be used. Examples of a charge control agent for positive charge control include quaternary ammonium salts, pyrimidine compounds, triphenylmethane derivatives, guanidine salts, and amidine salts.

Examples of a charge control agent for negative charge control include metal-containing azo compounds, azo complex dyes, metal complexes and metal salts of salicylic acid and derivatives thereof (the metal being chromium, zinc, zirconium, or the like), organic bentonite compounds, and boron compounds.

The content of the charge control agent in the toner particles according to the present embodiment is not particularly limited, but is preferably in a range from 0.5 mass % to 5 mass %. One of the charge control agents may be used individually, or two or more may be used in combination.

### 3. External Additives

The external additive usually has functions of improving the conveying property and the charging property of the toner, as well as the stirring property with a carrier when the toner is used in a two-component developer.

The toner according to the present embodiment includes two or more external additives having different average primary particle size. Therefore, the toner according to the present embodiment includes, as external additives, a first external additive and a second external additive having an average primary particle size larger than that of the first external additive.

The average primary particle size of the particles used as the first external additive is preferably in a range from 10 nm to 35 nm, more preferably in a range from 10 nm to 20 nm, and still more preferably in a range from 10 nm to 15 nm. If particles having an average primary particle size within the above-mentioned range are used as the first external additive, the toner particles have contact surfaces having appropriate slipperiness. This makes it possible to achieve both a function of retaining gaps between the toner particles before a load is applied to the toner and a function of relaxing stress when a load is applied to the toner.

The average primary particle size of the particles used as the second external additive is preferably in a range from 38 nm to 120 nm, and more preferably in a range from 40 nm to 115 nm. When the average primary particle size of the particles used as the second external additive is within the above-mentioned range, appropriate gaps can be provided between the toner particles in the filled toner. As a result, it is possible to relax stress when a load is applied to the toner.

The first external additive is preferably silica particles, titanium oxide particles, aluminum oxide particles, silica particles including aluminum hydroxide adhering to the surface thereof, or strontium titanate particles to which silica is added (hereinafter, also simply referred to as “silica-added strontium titanate particles”). Fumed silica is preferably used as the silica particles of the first external additive. Although silica particles, titanium oxide particles, aluminum oxide particles, or silica-added strontium titanate particles were actually used as the first external additive in Examples described later, silica particles including aluminum hydroxide adhering to the surface thereof can also be used as the first external additive, because such particles have an effect of stress relaxation, as well as an effect of suppressing charge reduction and fogging.

The second external additive preferably includes both silica particles and titanium oxide particles. As the silica particles serving as the second external additive, fumed silica may be used, but colloidal silica having a narrow particle size distribution is more preferably used.

Furthermore, two types of silica particles having different average primary particle size are preferably used as the silica particles of the second external additive. In other words, it is preferable that the silica particles serving as the first external additive are silica particles having small particle size, and the second external additive includes silica particles having medium particle size and silica particles having large particle size. In such a case, the average primary particle size of the silica particles having medium particle size is preferably in a range from 38 nm to 60 nm, and more preferably in a range from 40 nm to 50 nm. The average primary particle size of the silica particles having large particle size is preferably in a range from 90 nm to 120 nm, and more preferably in a range from 100 nm to 115 nm.

The average primary particle size of the titanium oxide particles serving as the second external additive is preferably in a range from 40 nm to 70 nm, and more preferably in a range from 45 nm to 60 nm.

The content of the first external additive in the toner according to the present embodiment is preferably in a range from 0.1 parts by mass to 0.5 parts by mass and more preferably in a range from 0.2 parts by mass to 0.4 parts by mass relative to 100 parts by mass of the toner particles. The content of the second external additive in the toner according to the present embodiment is preferably in a range from 4.0 parts by mass to 6.0 parts by mass and more preferably in a range from 4.2 parts by mass to 5.0 parts by mass relative to 100 parts by mass of the toner particles. When the contents of the first external additive and the second external additive are within the ranges described above, it is possible to achieve both the function of retaining gaps between the toner particles before a load is applied to the toner and the function of relaxing stress when a load is applied to the toner.

When the second external additive includes the silica particles having medium particle size, the silica particles having large particle size, and the titanium oxide particles, in the toner according to the present embodiment, the content of the silica particles having medium particle size is preferably in a range from 0.5 parts by mass to 1.5 parts by mass, the content of the silica particles having large particle size is preferably in a range from 2 parts by mass to 3 parts by mass, and the content of the titanium oxide particles is preferably in a range from 0.5 parts by mass to 1.5 parts by mass, relative to 100 parts by mass of the toner particles.

In the toner according to the present embodiment, the strength of adhesion of the first external additive to the toner particles is preferably in a range from 90% to 100%, and more preferably in a range from 95% to 100%. The strength of adhesion of the second external additive to the toner particles is preferably in a range from 30% to 50%, and more preferably in a range from 35% to 45%. According to the above-described mechanism, the strength of adhesion of the external additive affects the function of retaining gaps between the toner particles before a load is applied to the toner and the function of relaxing stress when a load is applied to the toner. Therefore, when the strength of adhesion of the first external additive and the second external additive is within the above-described ranges, both functions can be achieved, and thus, it is possible to prevent charge reduction and fogging when an image forming apparatus is operated for a long time.

The surface of the particles used as the external additive is preferably subjected to a hydrophobizing treatment. The hydrophobizing treatment is preferably a silanization. The silanization refers to a surface modification using a silane coupling agent, and examples of the silane coupling agent include hexamethyldisilazane (HMDS), dimethyl-dichlorosilane (DDS), octylsilane (OTAS), and polydimethylsiloxane (PDMS).

Examples of the silica particles as the external additive include silica particles commonly used in the art, including dry silica particles such as fumed silica obtained by burning silicon tetrachloride and arc silica obtained by atomizing silica in a gas phase by high energy such as a plasma; wet silica particles such as precipitated silica synthesized under alkaline conditions using an aqueous sodium silicate solution as a raw material and gel silica synthesized under acidic conditions; colloidal silica particles obtained by alkalization of acidic silicic acid and polymerization; and sol-gel silica particles obtained by hydrolysis of an organic silane compound. Such silica particles may be subjected to a surface treatment using a surface treatment agent such as the silane coupling agent described above, to improve electric characteristics of the photoconductor.

As the silica particles serving as the external additive, commercially available hydrophobized silica particles may be used, or non-hydrophobized silica particles may be subjected to a treatment before use.

Examples of the “silica particles including aluminum hydroxide adhering to the surface thereof” serving as the external additive include a fine powder including cores which are formed by a composition including aluminum hydroxide and silica and have a silanized surface. The main component of the composition forming the fine powder is silica, and aluminum hydroxide adheres to the surface of the silica. The content of aluminum hydroxide is, for example, in a range from 5 mass % to 15 mass %, and preferably about 10 mass %. The average primary particle size of the fine powder is preferably in a range from 10 nm to 35 nm, and more preferably in a range from 13 nm to 20 nm.

The fine powder as the “silica particles including aluminum hydroxide adhering to the surface thereof” can be produced, for example, by the procedure described in (1) to (4) below.

(1) Ion-exchanged water and hydrophilic fumed silica are mixed to obtain a dispersion of silica.

(2) The obtained dispersion is heated to 45° C., and then, a sodium aluminate solution having a concentration of Al(OH)₃ of 50 g/L and a 5 N aqueous sodium hydroxide solution are added dropwise to the dispersion until a pH of 6.0 is achieved. Next, 0.5 N diluted hydrochloric acid is added such that the dispersion has a pH of 3 to 4, and then, γ-aminopropyltriethoxysilane is added. Subsequently, a 2 N aqueous sodium hydroxide solution is added so that the dispersion has a pH of 6.5, and the obtained dispersion is filtered to obtain a wet cake. The obtained wet cake is washed with water and then dried to obtain a dried product 1.

(3) The dried product 1 is pulverized by a collision plate type jet mill to obtain a pulverized product. The pulverized product is added to a surface treatment solution obtained by adding and mixing n-hexane and amino-modified silicone oil, and the mixture is stirred to obtain a mixed solution. The obtained mixed solution is heated to 70° C., stirred, and dried with a vacuum dryer until the mass of the content does not decrease any more, to obtain a dried product 2.

(4) The dried product 2 is heated in an electric furnace at 200° C. for 3 hours and then cooled to obtain an aggregate of a composition including silica and aluminum hydroxide. The obtained aggregate is pulverized by a collision plate type jet mill to obtain a desired fine powder.

Examples of the “strontium titanate particles to which silica is added” (silica-added strontium titanate particles) as the external additive include a fine powder including cores which are formed by strontium titanate to which silica is added and have a surface that is subjected to a hydrophobizing treatment with a silane compound. The average primary particle size of the fine powder is preferably in a range from 10 nm to 35 nm, and more preferably in a range from 20 nm to 30 nm.

The molar ratio of silicon to titanium Si/Ti in the fine powder serving as the “silica-added strontium titanate particles” is preferably 0.03 or more and less than 1.0, and more preferably in a range from 0.04 to 0.06. Si/Ti represents the content ratio of silica in the fine powder. If Si/Ti is less than the above-mentioned lower limit, the negative charge decreases, which means that a fog value may increase due to charge reduction in a high-humidity environment. If Si/Ti exceeds the above-mentioned upper limit, the negative charge increases, and in a low-humidity environment which causes charge increase, the adhesion between the toner and the carrier becomes stronger. In such a case, the toner supplied later is insufficiently mixed and developed in a state of being insufficiently charged. As a result, toner scattering may increase and the fog value may increase.

The fine powder as the “silica-added strontium titanate particles” can be produced, for example, by the procedure described in (1) to (5) below.

(1) Metatitanic acid obtained by a sulfuric acid method is subjected to a desulfurization bleaching treatment, and then, a desulfurization treatment is performed by adding an aqueous sodium hydroxide solution. Subsequently, the obtained solution is neutralized with hydrochloric acid, and filtered and washed with water to obtain a washed cake.

(2) Water is added to the washed cake to form a slurry, which is then subjected to a deflocculation treatment by adding hydrochloric acid. The obtained solution is referred to as a solution 1. The solution 1 is mixed with a solution 2 formed by an aqueous strontium chloride solution and a solution 3 formed by an aqueous sodium silicate solution. The mixing ratio of the solution 1, the solution 2, and the solution 3 is determined such that the molar ratio (Sr+Si)/Ti is in a range from 1.18 to 2.10.

(3) The mixed solution is heated to 90° C. in a nitrogen atmosphere, stirred for 2 hours while adding an aqueous sodium hydroxide solution, and then, stirred at 90° C. for 1 hour to allow the mixture to react.

(4) After completion of the reaction, the slurry is cooled to 50° C. and hydrochloric acid is added. The mixture is stirred for 1 hour, and the resulting precipitate is washed, separated by filtration, and dried.

(5) The obtained dried product is pulverized with a blender for 1 minute, and coarse particles are removed with a sieve to obtain a fine powder. The obtained fine powder base bodies are surface-coated with a silane coupling agent. Examples of a surface coating method using a silane coupling agent include a surface treatment commonly used in the art which uses hexamethyldisilazane (HMDS), dimethyl-dichlorosilane (DDS), octylsilane (OTAS), or polydimethylsiloxane (PDMS).

### 4. Method for Producing Toner

According to the contents of the disclosure, in the toner using the pulverized toner particles, it is possible to effectively prevent the external additive from being embedded into the toner particles. Therefore, the toner particles according to the present embodiment are preferably pulverized toner particles. In the disclosure, the pulverized toner particles refer to toner particles produced by a pulverization method.

Producing the toner particles via a pulverization method may include, for example, a mixing step of dry-mixing materials containing an internal additive such as a colorant and a binder resin with a mixer, a melt-kneading step of melt-kneading the obtained mixture with a kneader, a pulverizing step of pulverizing a solidified product obtained by cooling and solidifying the obtained melt-kneaded product with a pulverizer to obtain a finely pulverized product, and a classifying step of adjusting the particle size of the obtained finely pulverized product with a classifier or the like as necessary.

The method for producing the toner according to the present embodiment preferably includes a first external addition step of mixing the first external additive and the toner particles to cause the first external additive to adhere to the surface of the toner particles and a second external addition step of mixing the second external additive and the toner particles to cause the second external additive to adhere to the surface of the toner particles, and in the method, the second external addition step is preferably performed after the first external addition step. This makes it possible to adjust the strength of adhesion of the first external additive to the toner particles, so as to be greater than the strength of adhesion of the second external additive to the toner particles. This further makes it possible to produce the toner that can achieve both the function of retaining gaps between the toner particles before a load is applied to the toner and the function of relaxing stress when a load is applied to the toner.

Examples of a method for mixing the external additive with the toner particles include a method in which the toner particles and the external additive are mixed with an air flow mixer such as a Henschel mixer.

### 5. Two-Component Developer

A developer according to the present embodiment is a two-component developer including a toner and a carrier. The two-component developer can be produced by mixing the toner and the carrier using a known mixer. The mass ratio of the toner and the carrier is not particularly limited and is, for example, from 3:97 to 12:88.

The carrier is stirred and mixed with the toner in the developer tank and imparts a desired charge to the toner. Furthermore, the carrier functions as an electrode between a development device and the photoconductor and carries the charged toner to an electrostatic latent image on the photoconductor to form a toner image. The carrier is held on a magnet roller (developing roller) of the development device by magnetic force, used in development, and then returns to the developer tank again, where the carrier is stirred and mixed with new toner again. In this manner, the carrier is repeatedly used until the end of its life.

The carrier is composed of a carrier core material and a resin coating layer coating the surface of the carrier core material. The resin coating layer formed of a carrier resin may be treated with a coupling agent.

### Carrier Core Material

A carrier core material commonly used in the art can be used, and examples thereof include magnetic metals such as iron, copper, nickel, and cobalt, and magnetic metal oxides such as ferrite and magnetite. By using these carrier core materials, it is possible to produce a carrier suitable for a developer used in a magnetic brush developing method.

Among these carrier core materials, particles including a ferrite component are preferable as the carrier core material. Ferrite has a high saturation magnetization and can be used to produce a coated carrier having low density. Thus, when ferrite is used in a developer, the coated carrier is less likely to adhere to the photoconductor and a soft magnetic brush is formed, so that it is possible to obtain an image having high dot reproducibility.

Examples of the ferrite include zinc-based ferrite, nickel-based ferrite, copper-based ferrite, barium ferrite, strontium ferrite, nickel-zinc-based ferrite, manganese-magnesium-based ferrite, copper-magnesium-based ferrite, manganese-zinc-based ferrite, manganese-copper-zinc-based ferrite, and manganese-magnesium-strontium-based ferrite.

The ferrite can be produced by a known method. For example, ferrite raw materials such as Fe₂O₃ and Mg(OH)₂ are mixed, and the mixed powder is subjected to heating as provisional sintering in a heating furnace. The resulting provisionally sintered product is cooled and then pulverized on a vibration mill to produce particles having particle sizes of about 1 μm, and a dispersant and water are added to the pulverized powder to prepare a slurry. The slurry is wet-pulverized by a wet ball mill, and the obtained suspension is granulated and dried by a spray dryer to obtain ferrite particles.

The average primary particle size of the carrier core material is preferably in a range from 25 μm to 50 μm and more preferably in a range from 30 μm to 50 μm. When the average primary particle size of the carrier core material is in the ranges mentioned above, the toner can be stably transported to an electrostatic latent image formed on a photoconductor, and high-resolution image forming can be provided over a long period of time. If the average primary particle size of the carrier core material is smaller than the lower limit, it may be difficult to control the carrier adhesion. On the other hand, if the average primary particle size of the carrier core material is larger than the upper limit, it may not be possible to form a high-resolution image.

### Carrier Resin

The resin used to form the resin coating layer is not particularly limited. For example, resins commonly used in the art can be used, and examples thereof include a polyester resin, an acrylic resin, an acrylic modified resin, a silicone resin, and a fluororesin. One of these resins may be used individually, or two or more may be used in combination. Examples of the acrylic resin include polyacrylate, polymethyl methacrylate, polyethyl methacrylate, poly-n-butyl methacrylate, polyglycidyl methacrylate, fluorine-containing polyacrylate, a styrene-methacrylate copolymer, a styrene-butyl methacrylate copolymer, and a styrene-ethyl acrylate copolymer.

Examples of the commercially available acrylic resin include resins by the trade names of Dianal SE-5437 manufactured by Mitsubishi Rayon Co., Ltd., S-LEC PSE-0020 manufactured by Sekisui Chemical Co., Ltd., Himer ST95 manufactured by Sanyo Chemical Industries, Co., Ltd., and FM601 manufactured by Mitsui Chemicals, Inc.

The silicone resins can reduce toner spent and improve adhesion between the carrier core material and the resin coating layer. Among the silicone resins, a crosslinking silicone resin is preferable.

Examples of commercially available crosslinking silicone resins include products manufactured by Dow Corning Toray Co., Ltd., such as SR2400, SR2410, SR2411, SR2510, SR2405, 840RESIN, and 804RESIN, and products manufactured by Shin-Etsu Chemical Co., Ltd., such as KR350, KR271, KR272, KR274, KR216, KR280, KR282, KR261, KR260, KR255, KR266, KR251, KR155, KR152, KR214, KR220, X-4040-171, KR201, KR5202, and KR3093.

The resin forming the resin coating layer is preferably a silicone resin, particularly a crosslinking silicone resin, and may include other resins, as long as the preferable characteristics of the resin are not impaired. Examples of the other resins include epoxy resins, urethane resins, phenol resins, acrylic resins, styrene resins, polyamides, polyesters, acetal resins, polycarbonates, vinyl chloride resins, vinyl acetate resins, cellulose resins, polyolefins, and fluororesins, as well as copolymer resins and blended resins thereof. Among these resins, acrylic resins are preferable to achieve high chargeability. For example, to further improve moisture resistance, releasability, and the like of the resin coating layer formed of a silicone resin (particularly, a crosslinking silicone resin), a bifunctional silicone oil may be included.

### Conductive Fine Particles

The resin coating layer preferably contains conductive fine particles. This makes it possible to stably enhance the ability of the carrier to charge the toner. That is, charge up of carriers can be suppressed.

The conductive fine particles are not particularly limited, conductive fine particles commonly used in the art can be used, and examples thereof include conductive carbon black and oxides such as conductive titanium oxide and conductive tin oxide.

Addition of carbon black even in a small amount can contribute to electrical conductivity, and is suitable for a black toner. On the other hand, in a color toner, conductive titanium oxide doped with antimony is suitably used to eliminate concerns about detachment of carbon black from the resin coating layer.

The blending amount of the conductive fine particles is not particularly limited, and is preferably in a range from 1 part by mass to 25 parts by mass and more preferably in a range from 1 part by mass to 20 parts by mass relative to 100 parts by mass of the resin used to form the resin coating layer. When the blending amount of the conductive fine particles is less than the lower limit, an effect of blending the conductive fine particles may not be achieved. On the other hand, when the blending amount of the conductive fine particles exceeds the upper limit, the resin coating layer may not be uniformly formed.

### Coupling Agent

The resin coating layer may further include a coupling agent such as a silane coupling agent for the purpose of adjusting the charge amount of the toner. Among the silane coupling agents, a silane coupling agent containing an electron-donating functional group is preferable, and examples thereof include an amino group-containing silane coupling agent represented by the following formula.

(Y)ₙSi(R)ₘ

In the formula, Rs are the same or different and each represent a C₁ to C₄ alkyl group, a C₁ to C₄ alkoxy group, or a chlorine atom, Ys are the same or different and each represent a C₁ to C₁₀ saturated hydrocarbon group and/or aromatic hydrocarbon group containing an amino group, m and n each represent an integer from 1 to 3, and m+n=4 is satisfied.

In the formula, examples of the alkyl group represented by R include linear or branched alkyl groups having 1 to 4 carbon atoms such as a methyl group, an ethyl group, a propyl group, an isopropyl group, a butyl group, an isobutyl group, and a tert-butyl group, and among these groups, the methyl group is preferable.

In the formula, examples of the alkoxy group represented by R include linear or branched alkoxy groups having 1 to 4 carbon atoms such as a methoxy group, an ethoxy group, a propoxy group, an isopropoxy group, a butoxy group, an isobutoxy group, and a tert-butoxy group, and among these groups, the methoxy group and the ethoxy group are preferable.

In the above-mentioned formula, examples of the saturated hydrocarbon and/or aromatic hydrocarbon group containing an amino group and represented by Y include —(CH₂)ₐ-X (where X represents an amino group, an aminocarbonylamino group, an aminoalkylamino group, a phenylamino group, or a dialkylamino group, and a is an integer from 1 to 4), and -Ph-X (where X is as defined above, and -Ph- represents a phenylene group).

Specific examples of the amino group-containing silane coupling agent include the following compounds.
H₂N(H₂C)₃Si(OCH₃)₃
H₂N(H₂C)₃Si(OC₂H₅)₃
H₂N(H₃C)₃Si(CH₃)(OCH₃)₂
H₂N(H₂C)₂HN(H₂C)₃Si(CH₃)(OCH₃)₂
H₂NOCHN(H₂C)₃Si(OC₂H₅)₃
H₂N(H₂C)₂HN(H₂C)₃Si(OCH₃)₃
H₂N-Ph-Si(OCH₃)₃(where -Ph- represents a p-phenylene group)
Ph-HN(H₂C)₃Si(OCH₃)₃(where Ph- represents a phenyl group)
(H₉C₄)₃N(H₂C)₃Si(OCH₃)₃

One of these coupling agents may be used individually, or two or more may be used in combination. The blending amount of the coupling agent is not particularly limited, and is preferably in a range from 1 part by mass to 15 parts by mass and more preferably in a range from 5 parts by mass to 15 parts by mass relative to 100 parts by mass of the carrier resin. When the blending amount of the coupling agent is within the above-mentioned ranges, a sufficient charge can be imparted to the toner without significant reduction of mechanical strength of the resin coating layer.

### EXAMPLES

Hereinafter, the toner and the two-component developer of the disclosure will be specifically described on the basis of Examples and Comparative Examples. First, various measurement methods and evaluation methods will be described.

### 1. Measurement Method and Evaluation Method

### Method for Measuring Apparent Viscosity of Toner Particles

A flow tester (manufactured by Shimadzu Corporation, trade name: CFT-100C) was used and set to apply a load of 10 kgf/cm² (0.98 MPa) and extrude 1 g of toner particles from a die (nozzle diameter of 1.0 mm, length of 1.0 mm). The toner particles were heated from 80° C. to 120° C. at a temperature increase rate of 6° C./min to determine the melt viscosity (apparent viscosity [Pa*s]).

### Method for Measuring Strength of Adhesion of External Additive to Toner Particles

The toner was subjected to an external additive adhesion strength test according to the following procedure.

(1) To 40 mL of a poly(oxyethylene) octylphenyl ether aqueous solution (manufactured by The Dow Chemical Company), trade name: Triton) having a concentration of 0.2 mass %, 2.0 g of a toner is added and stirred for 1 minute.

(2) The aqueous solution obtained in (1) is irradiated with ultrasonic waves having an output of 40 μA for 4 minutes using an ultrasonic homogenizer (manufactured by Nissei Co., Ltd., model: US-300T).

(3) Afterwards, the aqueous solution is allowed to stand for 3 hours, and the toner and external additives released from the toner are separated.

(4) After removing the supernatant, about 50 mL of pure water is added to the precipitate, and the mixture is stirred for 5 minutes.

(5) The mixture is suction-filtered using a membrane filter with a pore size of 1 m (available from Advantec Co., Ltd.).

(6) The toner remaining on the membrane filter is vacuum-dried overnight, and a toner after the external additive removal treatment is obtained.

(7) In the obtained toner after the external additive removal treatment and the toner before the external additive removal treatment, the X-ray intensity of a specific element included in the external additive is measured in 1 g of the toner by using an X-ray fluorescence spectrometer (manufactured by Rigaku Corporation, model: ZSXPrimus II).

An adhesion strength A of each element of the second external additive shown in Table 2 below is calculated by the following equation.

Adhesion strength A=(X-ray intensity of specific element after external additive removal treatment by ultrasonic irradiation for 4 minutes)/(X-ray intensity of specific element before external additive removal treatment)*100

Next, an external additive adhesion strength test was performed in a similar manner to (1) to (7) described above, except that the ultrasonic irradiation time in (2) was changed to 8 minutes. In this case, an adhesion strength Y of each element of the second external additive is calculated by the following equation.

Adhesion strength Y=(X-ray intensity of specific element after external additive removal treatment by ultrasonic irradiation for 8 minutes)/(X-ray intensity of specific element before external additive removal treatment)*100

An adhesion strength B of each element of the first external additive shown in Table 2 below is calculated by the following equation.

Adhesion strength B=1−(adhesion strength A−adhesion strength Y)

The use of this equation to calculate the adhesion strength B of each element of the first external additive is based on the fact that it is highly consistent with the cases where the first external additive and the second external additive include different elements, and the fact that SEM observation of the toner after the measurement of the adhesion strength A reveals that the external additive particles having particle sizes of 40 nm to 120 nm are mainly removed by the ultrasonic treatment.

A plurality of types of external additives were used as the second external additive in this example, and thus, based on the mass ratio of the added elements, the total adhesion strength A was calculated according to the following equation. In the following equation, specific elements 1 and 2 represent two types of specific elements in a plurality of types of external additives.

Adhesion strength A=(adhesion strength A of second external additive including specific element 1)*{(mass of second external additive including specific element 1)/(mass of second external additive including specific element 1+mass of second external additive including specific element 2)}+(adhesion strength A of second external additive including specific element 2)*{(mass of second external additive including specific element 2)/(mass of second external additive including specific element 1+mass of second external additive including specific element 2)}

### Method for Measuring Loose Bulk Density of Toner

After the toner was left to stand for 180 seconds, the loose bulk density of the toner was measured by measuring the weight of 30 mL of the toner using a bulk density measuring device (JIS-K-5101, manufactured by Ito Seisakusho Co., Ltd.).

### Method for Measuring Stress Relaxation Ratio of Toner

The stress relaxation ratio of the toner was measured using a powder rheometer (manufactured by Freeman Technology, model: FT4). The procedure is as follows.

(1) 30 g of a toner to be measured is placed in a 200 mL cylinder having an inner diameter of 50 mm.

(2) A silicone rubber heater is wrapped around the cylinder and used to heat the toner to 50° C. The temperature of the toner is measured with a type K thermocouple.

(3) A blade having a diameter of 48 mm is moved up and down while being rotated once every three minutes to stir the toner in the cylinder to eliminate temperature unevenness.

(4) The blade is removed and a piston having a diameter of 48 mm is mounted. The piston is lowered at a rate of 0.5 mm/see and is stopped when the load reaches 2 N. The volume of the compressed toner is held constant for 30 seconds. Stress relaxation occurs inside the compressed toner, and the load applied by the powder rheometer decreases with time and reaches a stable value after 30 seconds. This is recorded as “stress at 30 seconds after application of 2 N”.

(5) The piston is again lowered at a rate of 0.5 mm/sec. When the load reaches 3 N, the piston is stopped and the volume of the compressed toner is held constant for 30 seconds. This is recorded as “stress at 30 seconds after application of 3 N”.

(6) This measurement is repeated until the load reaches 40 N, and for each load application, the stress after 30 seconds is recorded.

The stress relaxation ratio of the toner is calculated by the following equation.

Stress relaxation ratio [%]=(initial stress at load application−stress after relaxation)/(initial stress at load application)*100

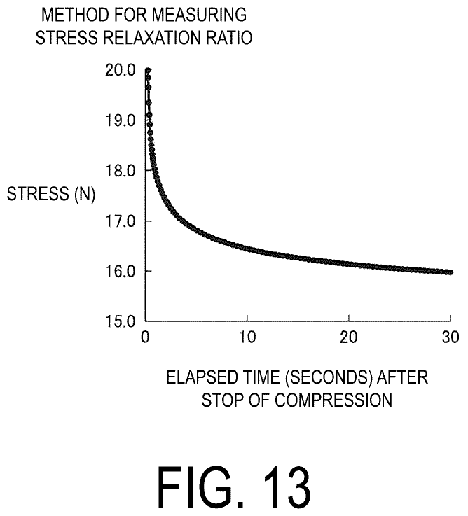

FIG. 13 is a graph showing a relationship between the stress of the toner and time when a load of 20 N is applied. In the case of this example, when the downward movement of the piston is stopped after the load of 20 N is applied and the piston stands still for 30 seconds such that the volume of the toner is held constant, the stress of the toner is relaxed as shown in the graph of FIG. 13. In this case, the stress is relaxed to the 16 N, and the stress relaxation ratio of the toner is calculated as follows.

Stress relaxation ratio [%]=(20 N−16 N)/20 N*100=20 [%]

The pressing force applied to the toner is calculated using the cross-sectional area of a piston having a diameter of 48 mm. The numerical values of the stress relaxation ratio shown in Table 3 below were obtained by measuring the stress relaxation ratio of the toner when the toner was compressed at 1.2 N/cm².

### Method for Measuring Compression Degree of Toner

The compression degree of the toner was calculated from the values of the loose bulk density and the packed bulk density by using the following equation. The method for measuring the loose bulk density is as described above. The packed bulk density was defined as the toner density when the toner was compressed at 1.2 N/cm² in the measurement of the stress relaxation ratio of the toner described above.

Compression degree [%]=(packed bulk density−loose bulk density)/(packed bulk density)*100

### Method for Measuring Average Primary Particle Size of External Additive

Images of the toner particles were captured by using a scanning electron microscope (SEM) (manufactured by Hitachi High-Technologies Corporation, model: S-4800). The particle sizes (major axes) of randomly selected 100 external additive particles on the toner surface were measured in the obtained image. The average value of the particle sizes of the 100 particles was calculated as the average primary particle size of the external additive.

### Method for Evaluating Durability of Developer

### —Evaluation Method Based on Fog Value—

A color multifunction machine (manufactured by SHARP CORPORATION, model: BP-20C25) was used as an evaluation machine. The evaluation machine was operated at a temperature of 30° C. and a humidity of 85% RH in an environmental test room. An image in which a region corresponding to 1% of the printable area of an A4 sheet was covered with a cyan toner was printed on 90000 sheets. The brightness of a specific location in the image that was not covered was measured using a colorimetric color difference meter (manufactured by NIPPON DENSHOKU INDUSTRIES Co., Ltd., model: ZE6000). The difference between this brightness and the brightness before printing measured in advance was defined as the fog value. A specified value of the fog value refers to a specified value determined according to the evaluation machine and the evaluation content. The “fogging degree” in Table 3 below indicates a ratio [%] of a measured value to a specified value of the fog value.

The evaluation criteria based on the fog value are as follows.
Excellent: the measured value was 80% or less relative to the specified value of the fog value.
Good: the measured value was more than 80% and 90% or less relative to the specified value of the fog value.
Marginal: the measured value was more than 90% and 100% or less relative to the specified value of the fog value.
Poor: the measured value was more than 100% relative to the specified value of the fog value.

### —Evaluation Method Based on Charge Reduction Ratio —

The toner charge amount of the developer after printing 90000 sheets in the above-described “evaluation method based on fog value” was measured using a suction-type charge amount measuring device (manufactured by TREK, Inc., model: 210HS-2A), and compared with the toner charge amount of the developer before printing 90000 sheets. The toner concentration in the developer after printing was different from that before printing. Therefore, the charge amounts were converted such that comparison under the same condition in terms of toner concentration was possible.

The evaluation criteria based on the charge reduction ratio are as follows.
Excellent: the charge amount after printing 90000 sheets was more than 80% relative to the charge amount of the developer in the initial state.
Good: the charge amount after printing 90000 sheets was more than 75% and 80% or less relative to the charge amount of the developer in the initial state.
Marginal: the charge amount after printing 90000 sheets was more than 70% and 75% or less relative to the charge amount of the developer in the initial state.
Poor: the charge amount after printing 90000 sheets was 70% or less relative to the charge amount of the developer in the initial state.

### 2. Production Example of Toner and Two-component Developer

### Preparation Step of Toner Particles

### —Preparation of Toner Particles (I)—

The following toner materials were used to prepare toner particles (toner cores).
Binder resin
Amorphous polyester resin, 62 mass %
Crystalline polyester resin, 25 mass %
Colorant
C.I. Pigment Blue 15:3 (manufactured by DIC Corporation), 7 mass %
Release agent
Ester wax (manufactured by NOF Corporation, trade name: WEP-5), 5 mass %
Charge control agent
Salicylic acid compound (manufactured by Orient Chemical Industries Co., Ltd., trade
name: Bontron E-84), 1 mass %

The above-mentioned materials were premixed for 5 minutes using a Henschel mixer (manufactured by Nippon Coke & Engineering Co., Ltd., model: FM20C) and then melt-kneaded using an open roll type continuous kneader (manufactured by Nippon Coke & Engineering Co., Ltd., model: MOS320-1800), to obtain a melt-kneaded product [melt-kneading step]. The setting conditions of the open rolls included a supply side temperature of the heating roll of 130° C., a discharge side temperature of the heating roll of 100° C., a supply side temperature of the cooling roll of 40° C., and a discharge side temperature of the cooling roll of 25° C. Rolls having a diameter of 320 mm and an effective length of 1550 mm were used as the heating roll and the cooling roll, and the gaps between the rolls on the supply side and the discharge side were both set to 0.3 mm. Furthermore, the rotation speed of the heating roll was set to 75 rpm, the rotation speed of the cooling roll to 65 rpm, and the supply amount of the toner materials was set to 5.0 kg/h.

The obtained melt-kneaded product was cooled with a cooling belt and then coarsely pulverized using a speed mill with a (p 2 mm screen, to obtain a coarsely pulverized product w[coarse pulverization step].

The obtained coarsely pulverized product was finely pulverized using a jet pulverizer (available from Nippon Pneumatic Mfg. Co., Ltd., model: IDS-2), to obtain a finely pulverized product [fine pulverization step].

Subsequently, the obtained finely pulverized product was classified using an elbow jet classifier (manufactured by Nittetsu Mining Co., Ltd., model: EJ-LABO), and toner particles (I) having an average primary particle size of 6.0 m were obtained [classifying step].

### —Preparation of Toner Particles (II) —

Toner particles (II) were prepared similarly as described above in “Preparation of Toner Particles (I)”, except that the mixing ratio of the binder resin was changed as follows.
Binder resin
Amorphous polyester resin, 47 mass %
Crystalline polyester resin, 40 mass %

### —Preparation of Toner Particles (III) —

Toner particles (III) were prepared similarly as described above in “Preparation of Toner Particles (I)”, except that the mixing ratio of the binder resin was changed as follows.
Binder resin
Amorphous polyester resin, 87 mass %

### External Addition Step (Step of Preparing Toner)

### Example 1

The external addition step for causing the external additive to adhere to the surfaces of the toner particles was divided into a first external addition step and a second external addition step. In the first external addition step, 100 parts by mass of the toner particles (I) and 0.3 parts by mass of silica particles (average primary particle size: 12 nm, manufactured by TAYCA Co., Ltd., trade name: MSN-002) were placed in a vessel, and the contents of the vessel were mixed using a Henschel mixer (manufactured by Nippon Coke & Engineering Co., Ltd., model: FM20C) at a rotational speed of 3500 rpm for 120 seconds.

Next, in the second external addition step, 0.95 parts by mass of silica particles (average primary particle size: 40 nm, manufactured by NIPPON AEROSIL CO., LTD., trade name: RY50), 0.95 parts by mass of titanium oxide particles (average primary particle size: 50 nm, manufactured by FUJI TITANIUM INDUSTRY CO., LTD., trade name: TAF-500MSA), and 2.5 parts by mass of silica particles (average primary particle size: 110 nm, manufactured by Shin-Etsu Chemical Co., Ltd., trade name: X-24-9163A) were added into the vessel and the content was mixed at a rotation speed of 3500 rpm for 180 seconds. The resulting mixture was sieved using a 270-mesh sieve, to obtain a toner of Example 1.

### Example 2

A toner of Example 2 was prepared in the same manner as in Example 1, except that the silica particles having an average primary particle size of 12 nm (manufactured by TAYCA Co., Ltd., trade name: MSN-002) in the external additive added in the first external addition step were replaced with silica particles having an average primary particle size of 7 nm (manufactured by NIPPON AEROSIL CO., LTD., trade name: R976S).

### Example 3

A toner of Example 3 was prepared in the same manner as in Example 1, except that the silica particles having an average primary particle size of 12 nm (manufactured by TAYCA Co., Ltd., trade name: MSN-002) in the external additive added in the first external addition step were replaced with silica particles having an average primary particle size of 37 nm (manufactured by Cabot Corporation, trade name: TG-5180).

### Example 4

A toner of Example 4 was prepared in the same manner as in Example 1, except that the silica particles having an average primary particle size of 110 nm (manufactured by Shin-Etsu Chemical Co., Ltd., trade name: X-24-9163A) in the external additive added in the second external addition step were replaced with silica particles having an average primary particle size of 37 nm (manufactured by Cabot Corporation, trade name: TG-5180).

### Example 5

A toner of Example 5 was prepared in the same manner as in Example 1, except that the silica particles having an average primary particle size of 110 nm (manufactured by Shin-Etsu Chemical Co., Ltd., trade name: X-24-9163A) in the external additive added in the second external addition step were replaced with silica particles having an average primary particle size of 200 nm (manufactured by Cabot Corporation, trade name: TG-C6020).

### Example 6

A toner of Example 6 was prepared in the same manner as in Example 1, except that the amount of the silica particles having an average primary particle size of 110 nm (manufactured by Shin-Etsu Chemical Co., Ltd., trade name: X-24-9163A) which is added in the second external addition step was changed from 2.5 parts by mass to 2.0 parts by mass.

### Example 7

A toner of Example 7 was prepared in the same manner as in Example 1, except that the amount of the silica particles having an average primary particle size of 110 nm (manufactured by Shin-Etsu Chemical Co., Ltd., trade name: X-24-9163A) which is added in the second external addition step was changed from 2.5 parts by mass to 4.2 parts by mass.

### Example 8

A toner of Example 8 was prepared in the same manner as in Example 1, except that the mixing time in the first external addition step (first external addition time) was changed from 120 seconds to 60 seconds.

### Example 9

A toner of Example 9 was prepared in the same manner as in Example 1, except that the mixing time in the second external addition step (second external addition time) was changed from 180 seconds to 150 seconds.

### Example 10

A toner of Example 10 was prepared in the same manner as in Example 1, except that the mixing time in the second external addition step (second external addition time) was changed from 180 seconds to 240 seconds.

### Example 11

A toner of Example 11 was prepared in the same manner as in Example 1, except that the silica particles having an average primary particle size of 12 nm (manufactured by TAYCA Co., Ltd., trade name: MSN-002) in the external additive added in the first external addition step were replaced with titanium oxide particles having an average primary particle size of 15 nm (manufactured by TAYCA Co., Ltd., trade name: MTX150AO).

### Example 12

A toner of Example 12 was prepared in the same manner as in Example 1, except that the silica particles having an average primary particle size of 12 nm (manufactured by TAYCA Co., Ltd., trade name: MSN-002) in the external additive added in the first external addition step were replaced with aluminum oxide particles having an average primary particle size of 13 nm (manufactured by NIPPON AEROSIL CO., LTD., trade name: C805).

### Example 13

A toner of Example 13 was prepared in the same manner as in Example 1, except that the silica particles having an average primary particle size of 12 nm (manufactured by TAYCA Co., Ltd., trade name: MSN-002) in the external additive added in the first external addition step were replaced with silica-added strontium titanate particles having an average primary particle size of 25 nm. The silica-added strontium titanate particles prepared according to the following procedure were used.

(1) Metatitanic acid obtained by a sulfuric acid method was subjected to a deironization bleaching treatment, and then, a desulfurization treatment was performed by adding an aqueous sodium hydroxide solution. Subsequently, the obtained solution was neutralized with hydrochloric acid, and filtered and washed with water to obtain a washed cake.

(2) Water was added to the washed cake to form a slurry, which was then subjected to a deflocculation treatment by adding hydrochloric acid. The obtained solution was referred to as a solution 1. The solution 1 was mixed with a solution 2 formed by an aqueous strontium chloride solution and a solution 3 formed by an aqueous sodium silicate solution. The mixing ratio of the solution 1, the solution 2, and the solution 3 was determined such that the molar ratio (Sr+Si)/Ti was 1.2.

(3) The mixed solution was heated to 90° C. in a nitrogen atmosphere, and then, stirred for 2 hours while adding an aqueous sodium hydroxide solution to allow the mixture to react.

(4) After completion of the reaction, the slurry was cooled to 50° C., and hydrochloric acid was added. The mixture was stirred for 2 hour, and the resulting precipitate was washed, separated by filtration, and dried.

(5) The obtained dried product was pulverized with a blender for 1 minute, and coarse particles were removed with a sieve to obtain a fine powder. The obtained fine powder base bodies were surface-coated with a silane coupling agent (dimethyl-dichlorosilane (DDS)).

### Example 14

A toner of Example 14 was prepared in the same manner as in Example 1 except that, instead of using, in the second external addition step, the combination of the silica particles having an average primary particle size of 40 nm and the silica particles having an average primary particle size of 110 nm, 3.45 parts by mass of the silica particles having an average primary particle size of 110 nm (manufactured by Shin-Etsu Chemical Co., Ltd., trade name: X-24-9163A) were used.

### Comparative Example 1

A toner of Comparative Example 1 was prepared in the same manner as in Example 1, except that the toner particles (II) were used instead of the toner particles (I).

### Comparative Example 2

A toner of Comparative Example 2 was prepared in the same manner as in Example 1, except that the toner particles (III) were used instead of the toner particles (I).

### Comparative Example 3

A toner of Comparative Example 3 was prepared in the same manner as in Example 1, except that the amount of the silica particles having an average primary particle size of 12 nm (manufactured by TAYCA Co., Ltd., trade name: MSN-002) which is added in the first external addition step, was changed from 0.3 parts by mass to 0.6 parts by mass.

### Comparative Example 4

Comparative Example 4 is an example in which the first external addition step in Example 1 was not performed, only the second external addition step was performed, and the mixing time was changed to 290 seconds (corresponding to the time obtained by subtracting 10 seconds (rotation start-up time of the Henschel mixer) from 300 seconds).

Specifically, 100 parts by mass of the toner particles (I), 0.95 parts by mass of silica particles (average primary particle size: 40 nm, manufactured by NIPPON AEROSIL CO., LTD., trade name: RY50), 0.95 parts by mass of titanium oxide particles (average primary particle size: 50 nm, manufactured by FUJI TITANIUM INDUSTRY CO., LTD., trade name: TAF-500MSA), and 2.5 parts by mass of silica particles (average primary particle size: 110 nm, manufactured by Shin-Etsu Chemical Co., Ltd., trade name: X-24-9163A) were placed into a vessel, and the content of the vessel was mixed using a Henschel mixer (manufactured by Nippon Coke & Engineering Co., Ltd., model: FM20C) at a rotational speed of 3500 rpm for 290 seconds. The resulting mixture was sieved using a 270-mesh sieve, to obtain a toner of Comparative Example 4.

### Comparative Example 5

A toner of Comparative Example 5 was prepared in the same manner as in Example 1, except that the amount of the silica particles having an average primary particle size of 12 nm (manufactured by TAYCA Co., Ltd., trade name: MSN-002) which is added in the first external addition step, was changed from 0.3 parts by mass to 1.2 parts by mass, and the mixing time (first external addition time) was changed from 120 seconds to 40 seconds.

### Step of Preparing Carrier

A coating liquid was prepared by dissolving, in 12 parts by mass of toluene, 0.375 parts by mass of silicone resin 1 (manufactured by Shin-Etsu Chemical Co., Ltd., trade name: KR240) and 0.375 parts by mass of silicone resin 2 (manufactured by Shin-Etsu Chemical Co., Ltd., trade name: KR251), and dispersing, in the solution, 0.0375 parts by mass of conductive fine particles (manufactured by Cabot Corporation, trade name: VULCAN XC-72) and 0.0225 parts by mass of a coupling agent (manufactured by Dow Corning Toray Co., Ltd., trade name: AY43-059). 12.8 parts by mass of the coating resin liquid was used with respect to 100 parts by mass of the carrier core material. The surface of the carrier core material was coated with the coating resin liquid by using a dipping method. After a curing process using a curing temperature of 200° C. and a curing time of 1 hour, and sieving using a sieve having a mesh size of 150 m, a carrier was obtained.

### Step of Preparing Two-Component Developer

The prepared carriers were combined with the toners of Examples 1 to 14 and Comparative Examples 1 to 5 to prepare two-component developers of Examples 1 to 14 and Comparative Examples 1 to 5. These two-component developers were prepared by being mixed in a V-shaped mixer (manufactured by Tokuju Corporation, trade name: V-5) for 20 minutes so as to obtain a toner concentration of 7 mass %.

TABLE 1

| | | Added first external additive | | | Added second external additive | | | |
|---|---|---|---|---|---|---|---|---|
| | | material (first external additive) | | | material (second external additive) | | | |
| | | | Particle | | | Particle | | |
| | Toner | Material | size | | Material | size | | Material |
| | particles | type | (nm) | wt % | type 1 | (nm) | wt % | type 2 |
| Example 1 | I | Silica | 12 | 0.3 | Silica | 40 | 0.95 | Titanium |
| | | | | | | | | oxide |
| Example 2 | I | Silica | 7 | 0.3 | Silica | 40 | 0.95 | Titanium |
| | | | | | | | | oxide |
| Example 3 | I | Silica | 37 | 0.3 | Silica | 40 | 0.95 | Titanium |
| | | | | | | | | oxide |
| Example 4 | I | Silica | 12 | 0.3 | Silica | 40 | 0.95 | Titanium |
| | | | | | | | | oxide |
| Example 5 | I | Silica | 12 | 0.3 | Silica | 40 | 0.95 | Titanium |
| | | | | | | | | oxide |
| Example 6 | I | Silica | 12 | 0.3 | Silica | 40 | 0.95 | Titanium |
| | | | | | | | | oxide |
| Example 7 | I | Silica | 12 | 0.3 | Silica | 40 | 0.95 | Titanium |
| | | | | | | | | oxide |
| Example 8 | I | Silica | 12 | 0.3 | Silica | 40 | 0.95 | Titanium |
| | | | | | | | | oxide |
| Example 9 | I | Silica | 12 | 0.3 | Silica | 40 | 0.95 | Titanium |
| | | | | | | | | oxide |
| Example 10 | I | Silica | 12 | 0.3 | Silica | 40 | 0.95 | Titanium |
| | | | | | | | | oxide |
| Example 11 | I | Titanium | 15 | 0.3 | Silica | 40 | 0.95 | Titanium |
| | | oxide | | | | | | oxide |
| Example 12 | I | Aluminum | 13 | 0.3 | Silica | 40 | 0.95 | Titanium |
| | | oxide | | | | | | oxide |
| Example 13 | I | Silica- | 25 | 0.3 | Silica | 40 | 0.95 | Titanium |
| | | added | | | | | | oxide |
| | | strontium | | | | | | |
| | | titanate | | | | | | |
| Example 14 | I | Silica | 12 | 0.3 | — | — | — | Titanium |
| | | | | | | | | oxide |
| Comparative | II | Silica | 12 | 0.3 | Silica | 40 | 0.95 | Titanium |
| Example 1 | | | | | | | | oxide |
| Comparative | III | Silica | 12 | 0.3 | Silica | 40 | 0.95 | Titanium |
| Example 2 | | | | | | | | oxide |
| Comparative | I | Silica | 12 | 0.6 | Silica | 40 | 0.95 | Titanium |
| Example 3 | | | | | | | | oxide |
| Comparative | I | — | — | 0 | Silica | 40 | 0.95 | Titanium |
| Example 4 | | | | | | | | oxide |
| Comparative | I | Silica | 12 | 1.2 | Silica | 40 | 0.95 | Titanium |
| Example 5 | | | | | | | | oxide |

| | | | | | | Total | | |
|---|---|---|---|---|---|---|---|---|
| | | | | | | addition | | |
| | Added second external additive | | | | | amount | First | Second |
| | material (second external additive) | | | | | of second | external | external |
| | Particle | | | Particle | | external | addition | addition |
| | size | | Material | size | | additive | time | time |
| | (nm) | wt % | type 3 | (nm) | wt % | [wt %] | [seconds] | [seconds] |
| Example 1 | 50 | 0.95 | Silica | 110 | 2.5 | 4.4 | 120 | 180 |
| Example 2 | 50 | 0.95 | Silica | 110 | 2.5 | 4.4 | 120 | 180 |
| Example 3 | 50 | 0.95 | Silica | 110 | 2.5 | 4.4 | 120 | 180 |
| Example 4 | 50 | 0.95 | Silica | 37 | 2.5 | 4.4 | 120 | 180 |
| Example 5 | 50 | 0.95 | Silica | 200 | 2.5 | 4.4 | 120 | 180 |
| Example 6 | 50 | 0.95 | Silica | 110 | 2.0 | 3.9 | 120 | 180 |
| Example 7 | 50 | 0.95 | Silica | 110 | 4.2 | 6.1 | 120 | 180 |
| Example 8 | 50 | 0.95 | Silica | 110 | 2.5 | 4.4 | 60 | 180 |
| Example 9 | 50 | 0.95 | Silica | 110 | 2.5 | 4.4 | 120 | 150 |
| Example 10 | 50 | 0.95 | Silica | 110 | 2.5 | 4.4 | 120 | 240 |
| Example 11 | 50 | 0.95 | Silica | 110 | 2.5 | 4.4 | 120 | 180 |
| Example 12 | 50 | 0.95 | Silica | 110 | 2.5 | 4.4 | 120 | 180 |
| Example 13 | 50 | 0.95 | Silica | 110 | 2.5 | 4.4 | 120 | 180 |
| Example 14 | 50 | 0.95 | Silica | 110 | 3.45 | 4.4 | 120 | 180 |
| Comparative | 50 | 0.95 | Silica | 110 | 2.5 | 4.4 | 120 | 180 |
| Example 1 | | | | | | | | |
| Comparative | 50 | 0.95 | Silica | 110 | 2.5 | 4.4 | 120 | 180 |
| Example 2 | | | | | | | | |
| Comparative | 50 | 0.95 | Silica | 110 | 2.5 | 4.4 | 120 | 180 |
| Example 3 | | | | | | | | |
| Comparative | 50 | 0.95 | Silica | 110 | 2.5 | 4.4 | — | 290 |
| Example 4 | | | | | | | | |
| Comparative | 50 | 0.95 | Silica | 110 | 2.5 | 4.4 | 40 | 180 |
| Example 5 | | | | | | | | |

TABLE 2

| | Specific element | | | Specific | | | | | Addition | |
|---|---|---|---|---|---|---|---|---|---|---|
| | in second | | | element | Measured adhesion strength | | | | amount of | |
| | external additive | | | in first | A (Second external additive, | | | | each element | |
| | Material | Material | Material | external | after 4 minutes) | | | | Si | Ti |
| | type 1 | type 2 | type 3 | additive | Si | Ti | Sr | Al | [wt %] | [wt %] |
| Example 1 | Si | Ti | Si | Si | 30% | 60% | — | — | 3.75 | 0.95 |
| Example 2 | Si | Ti | Si | Si | 30% | 60% | — | — | 3.75 | 0.95 |
| Example 3 | Si | Ti | Si | Si | 30% | 60% | — | — | 3.75 | 0.95 |
| Example 4 | Si | Ti | Si | Si | 30% | 60% | — | — | 3.75 | 0.95 |
| Example 5 | Si | Ti | Si | Si | 30% | 60% | — | — | 3.75 | 0.95 |
| Example 6 | Si | Ti | Si | Si | 30% | 60% | — | — | 3.25 | 0.95 |
| Example 7 | Si | Ti | Si | Si | 30% | 60% | — | — | 5.45 | 0.95 |
| Example 8 | Si | Ti | Si | Si | 29% | 60% | — | — | 3.75 | 0.95 |
| Example 9 | Si | Ti | Si | Si | 25% | 40% | — | — | 3.75 | 0.95 |
| Example 10 | Si | Ti | Si | Si | 53% | 63% | — | — | 3.75 | 0.95 |
| Example 11 | Si | Ti | Si | Ti | 30% | 60% | — | — | 3.45 | 1.25 |
| Example 12 | Si | Ti | Si | Al | 30% | 60% | — | 100% | 3.45 | 0.95 |
| Example 13 | Si | Ti | Si | Sr | 30% | 60% | 100% | — | 3.45 | 0.95 |
| Example 14 | — | Ti | Si | Si | 35% | 60% | — | — | 3.75 | 0.95 |
| Comparative | Si | Ti | Si | Si | 28% | 59% | — | — | 3.75 | 0.95 |
| Example 1 | | | | | | | | | | |
| Comparative | Si | Ti | Si | Si | 32% | 63% | — | — | 3.75 | 0.95 |
| Example 2 | | | | | | | | | | |
| Comparative | Si | Ti | Si | Si | 29% | 60% | — | — | 4.05 | 0.95 |
| Example 3 | | | | | | | | | | |
| Comparative | Si | Ti | Si | Si | 35% | 68% | — | — | 3.45 | 0.95 |
| Example 4 | | | | | | | | | | |
| Comparative | Si | Ti | Si | Si | 25% | 57% | — | — | 4.65 | 0.95 |
| Example 5 | | | | | | | | | | |

| | | | | Adhesion strength | | | | | | | |
|---|---|---|---|---|---|---|---|---|---|---|---|
| | | | Adhesion | Y (Second external | | | | Adhesion strength | | | |
| | | | strength | additive, after 10 | | | | B (First external | | | |
| | Mass ratio | | A | Mminutes) | | | | additive) | | | |
| | Si | Ti | (Total) | Si | Ti | Sr | Al | Si | Ti | Sr | Al |
| Example 1 | 80% | 20% | 36% | 28% | — | — | — | 98% | — | — | — |
| Example 2 | 80% | 20% | 36% | 28% | — | — | — | 98% | — | — | — |
| Example 3 | 80% | 20% | 36% | 28% | — | — | — | 98% | — | — | — |
| Example 4 | 80% | 20% | 36% | 28% | — | — | — | 98% | — | — | — |
| Example 5 | 80% | 20% | 36% | 28% | — | — | — | 98% | — | — | — |
| Example 6 | 77% | 23% | 37% | 28% | — | — | — | 98% | — | — | — |
| Example 7 | 85% | 15% | 34% | 28% | — | — | — | 98% | — | — | — |
| Example 8 | 80% | 20% | 35% | 17% | — | — | — | 88% | — | — | — |
| Example 9 | 80% | 20% | 28% | 24% | — | — | — | 99% | — | — | — |
| Example 10 | 80% | 20% | 55% | 52% | — | — | — | 99% | — | — | — |
| Example 11 | 73% | 27% | 38% | — | 58% | — | — | — | 98% | — | — |
| Example 12 | 78% | 22% | 36% | — | — | — | 98% | — | — | — | 98% |
| Example 13 | 78% | 22% | 36% | — | — | 99% | — | — | — | 99% | — |
| Example 14 | 80% | 20% | 40% | 31% | — | — | — | 96% | — | — | — |
| Comparative | 80% | 20% | 34% | 25% | — | — | — | 97% | — | — | — |
| Example 1 | | | | | | | | | | | |
| Comparative | 80% | 20% | 38% | 31% | — | — | — | 99% | — | — | — |
| Example 2 | | | | | | | | | | | |
| Comparative | 81% | 19% | 35% | 28% | — | — | — | 99% | — | — | — |
| Example 3 | | | | | | | | | | | |
| Comparative | 78% | 22% | 42% | — | — | — | — | — | — | — | — |
| Example 4 | | | | | | | | | | | |
| Comparative | 83% | 17% | 30% | 14% | — | — | — | 89% | — | — | — |
| Example 5 | | | | | | | | | | | |

TABLE 3

| | Apparent | | | | | | |
|---|---|---|---|---|---|---|---|
| | viscosity of | Loose | | Stress | First external additive | | |
| | toner particles | bulk | Compression | relaxation | Particle | Addition | Adhesion |
| | at 90° C. | density | degree | ratio | size | amount | strength B |
| | [Pa*s] | [g/cm³] | [%] | [%] | [nm] | [wt %] | [%] |
| Example 1 | 117600 | 0.335 | 48.2 | 31.5 | 12 | 0.3 | 98% |
| Example 2 | 117600 | 0.340 | 48.8 | 31.2 | 7 | 0.3 | 98% |
| Example 3 | 117600 | 0.330 | 47.4 | 31.1 | 37 | 0.3 | 98% |
| Example 4 | 117600 | 0.342 | 49.1 | 30.6 | 12 | 0.3 | 98% |
| Example 5 | 117600 | 0.333 | 47.8 | 30.9 | 12 | 0.3 | 98% |
| Example 6 | 117600 | 0.332 | 47.6 | 28.8 | 12 | 0.3 | 98% |
| Example 7 | 117600 | 0.342 | 49.1 | 29.7 | 12 | 0.3 | 98% |
| Example 8 | 117600 | 0.350 | 50.0 | 27.1 | 12 | 0.3 | 88% |
| Example 9 | 117600 | 0.340 | 48.8 | 30.8 | 12 | 0.3 | 99% |
| Example 10 | 117600 | 0.321 | 46.1 | 28.1 | 12 | 0.3 | 99% |
| Example 11 | 117600 | 0.325 | 46.6 | 31.2 | 12 | 0.3 | 98% |
| Example 12 | 117600 | 0.320 | 46.2 | 30.2 | 13 | 0.3 | 97% |
| Example 13 | 117600 | 0.322 | 46.2 | 31.0 | 25 | 0.3 | 99% |
| Example 14 | 117600 | 0.310 | 49.2 | 30.2 | 12 | 0.3 | 96% |
| Comparative | 424900 | 0.400 | 52.6 | 3.2 | 12 | 1.0 | 97% |
| Example 1 | | | | | | | |
| Comparative | 90000 | 0.330 | 51.0 | 9.0 | 12 | 0.3 | 99% |
| Example 2 | | | | | | | |
| Comparative | 117600 | 0.345 | 51.2 | 10.2 | 12 | 0.6 | 99% |
| Example 3 | | | | | | | |
| Comparative | 117600 | 0.341 | 47.2 | 26.5 | — | 0.0 | — |
| Example 4 | | | | | | | |
| Comparative | 117600 | 0.396 | 54.1 | 3.8 | 12 | 1.2 | 89% |
| Example 5 | | | | | | | |

| | | | | Durability evaluation | | | |
|---|---|---|---|---|---|---|---|
| | | | | | | | Evaluation |
| | Second external additive | | | | | Charge | result of |
| | Particle | Addition | Adhesion | Fogging | Evaluation | reduction | charge |
| | size | amount | strength A | degree | result of | ratio | reduction |
| | [nm] | [wt %] | [%] | [%] | fog value | [%] | ratio |
| Example 1 | 40-110 | 4.4 | 36% | 75 | Excellent | 85.0 | Excellent |
| Example 2 | 40-110 | 4.4 | 36% | 91 | Marginal | 74.3 | Marginal |
| Example 3 | 40-110 | 4.4 | 36% | 89 | Good | 74.0 | Marginal |
| Example 4 | 37-50 | 4.4 | 36% | 91 | Marginal | 73.2 | Marginal |
| Example 5 | 40-200 | 4.4 | 36% | 88 | Good | 73.5 | Marginal |
| Example 6 | 40-110 | 3.9 | 37% | 97 | Marginal | 70.6 | Marginal |
| Example 7 | 40-110 | 6.1 | 34% | 88 | Good | 70.8 | Marginal |
| Example 8 | 40-110 | 4.4 | 35% | 98 | Marginal | 70.6 | Marginal |
| Example 9 | 40-110 | 4.4 | 28% | 92 | Marginal | 73.3 | Marginal |
| Example 10 | 40-110 | 4.4 | 55% | 88 | Good | 70.1 | Marginal |
| Example 11 | 40-110 | 4.4 | 36% | 74 | Excellent | 79.5 | Good |
| Example 12 | 40-110 | 4.4 | 36% | 88 | Good | 75.1 | Good |
| Example 13 | 40-110 | 4.4 | 36% | 74 | Excellent | 79.7 | Good |
| Example 14 | 50-110 | 4.4 | 31% | 88 | Good | 77.5 | Good |
| Comparative | 40-110 | 2.0 | 34% | 75 | Excellent | 85.0 | Excellent |
| Example 1 | | | | | (poor low- | | (poor low- |
| | | | | | temperature | | temperature |
| | | | | | fixing) | | fixing) |
| Comparative | 40-110 | 4.4 | 38% | 95 | Marginal | 55.0 | Poor |
| Example 2 | | | | | | | |
| Comparative | 40-110 | 4.4 | 35% | 103 | Poor | 68.0 | Poor |
| Example 3 | | | | | | | |
| Comparative | 40-110 | 4.4 | 42% | 101 | Poor | 74.5 | Marginal |
| Example 4 | | | | | | | |
| Comparative | 40-110 | 4.4 | 30% | 99 | Marginal | 65.0 | Poor |
| Example 5 | | | | | | | |

Table 1 shows the types and addition amounts of the external additives, the mixing times in the external addition steps (external addition times), and the like used in the preparation of the toners of the Examples and Comparative Examples.

Table 2 shows calculation results of the strength of adhesion of the external additive to the toner particles, for the Examples and Comparative Examples. In Table 2, values in the column of “adhesion strength A (total)” correspond to the “adhesion strength of the second external additive”, and values in the column of “adhesion strength B” correspond to the “adhesion strength of the first external additive”.

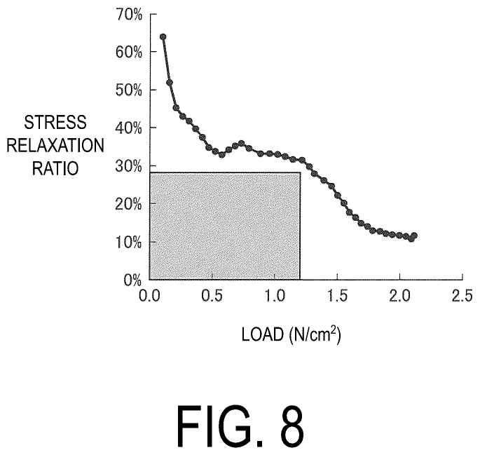

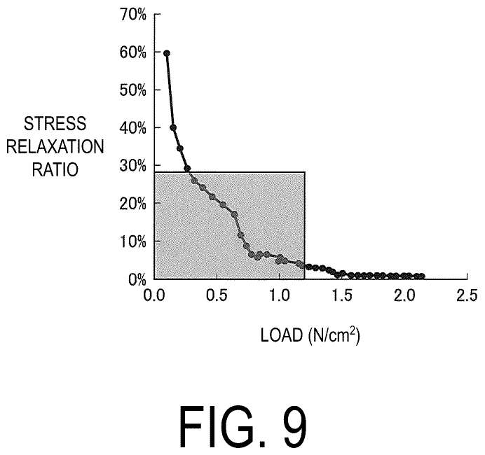

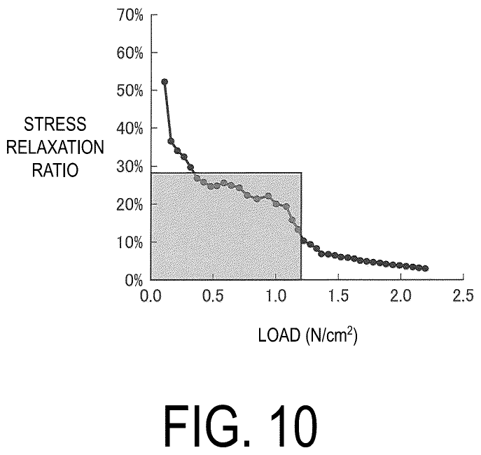

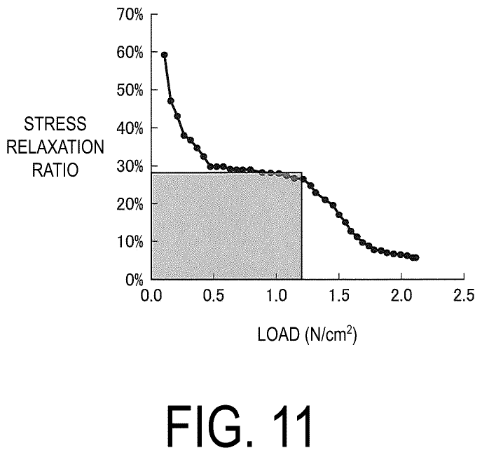

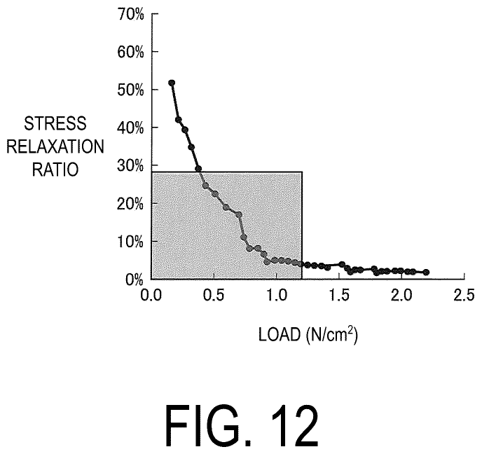

Table 3 shows physical property values and evaluation results of the Examples and Comparative Examples. FIGS. 8 to 12 are graphs showing measurement results of stress relaxation ratios of Example 1 and Comparative Examples 1 and 3 to 5. Note that the gray regions in the graphs are shown to make it easy to visually recognize whether the stress relaxation ratio of the toner is 27% or more when the toner is compressed at 1.2 N/cm². From FIG. 8, it can be visually recognize that the stress relaxation ratio in Example 1 is 27% or greater when compressed at 1.2 N/cm².

As can be clearly seen from the evaluation results in Table 3, the toners of Examples 1 to 14 satisfying the following requirements (A) to (D) can suppress charge reduction and fogging when the image forming apparatus is operated for a long time, without compromising low-temperature fixability.

(A) The toner particles include a crystalline polyester resin and a wax and have an apparent viscosity at 90° C. in a range from 100000 Pa*s to 200000 Pa*s.

(B) The external additives include a first external additive and a second external additive having an average primary particle size larger than that of the first external additive.

(C) The loose bulk density of the toner is in a range from 0.3 g/cm³ to 0.35 g/cm³.

(D) When the toner is compressed at 50° C. and 1.2 N/cm², a compression degree of the toner is 50% or less, and a stress relaxation ratio of the toner is 27% or more.

On the other hand, among Comparative Examples 1 to 5 which do not satisfy these requirements, Comparative Examples 2 to 5 were inferior to the Examples in at least one of the evaluation result based on the fog value and the evaluation result based on the charge reduction ratio. Comparative Example 1 is an example that does not correspond to a low-temperature fixable toner (an example inferior in low-temperature fixability). Therefore, in Table 3, the evaluation results based on the fog value and the charge reduction ratio for Comparative Example 1 are “Excellent (poor low-temperature fixing)”.

By comparing Example 1 with Examples 2 and 3, it was found that Example 1 including the first external additive having an average primary particle size within a range from 10 nm to 35 nm was superior in evaluation results based on the fog value and the charge reduction ratio, compared to Example 2 including the first external additive having an average primary particle size less than the lower limit of the range and Example 3 including the first external additive having an average primary particle size greater than the upper limit of the range.

By comparing Example 1 with Examples 4 and 5, it was found that Example 1 including, as the second external additives, the silica particles and the titanium oxide particles each having an average primary particle size within a range from 38 nm to 120 nm was superior in evaluation results based on the fog value and the charge reduction ratio, compared to Example 4 including, as the second external additive, the silica particles having an average primary particle size less than the lower limit of the range and Example 5 including, as the second external additive, the silica particles having an average primary particle size greater than the upper limit of the range.

By comparing Example 1 with Examples 6 and 7, it was found that Example 1 in which the content of the second external additive is within a range from 4.0 parts by mass to 6.0 parts by mass was superior in evaluation results based on the fog value and the charge reduction ratio, compared to Example 6 in which the content of the second external additive is less than the lower limit of the range and Example 7 in which the content of the second external additive is greater than the upper limit of the range.

By comparing Example 1 with Example 8, it was found that Example 1 in which the adhesion strength of the first external additive is within a range from 90% to 100% was superior in evaluation results based on the fog value and the charge reduction ratio, compared to Example 8 in which the adhesion strength of the first external additive is less than the lower limit of the range.

By comparing Example 1 with Examples 9 and 10, it was found that Example 1 in which the adhesion strength of the second external additive is within a range from 30% to 50% was superior in evaluation results based on the fog value and the charge reduction ratio, compared to Example 9 in which the adhesion strength of the second external additive is less than the lower limit of the range and Example 10 in which the adhesion strength of the second external additive is greater than the upper limit of the range.

In contrast to Example 1 and the like in which silica particles were used as the first external additive, titanium oxide particles were used as the first external additive in Example 11, aluminum oxide particles were used as the first external additive in Example 12, and silica-added strontium titanate particles were used as the first external additive in Example 13. From the evaluation results of Examples 11 to 13, it was found that, even in a case where the titanium oxide particles, the aluminum oxide particles, or the silica-added strontium titanate particles are used as the first external additive, charge reduction and fogging can be suppressed when the image forming apparatus is operated for a long time.

In contrast to Example 1 and the like in which silica particles having medium particle size (average primary particle size: 40 nm), silica particles having large particle size (average primary particle size: 110 nm), and titanium oxide particles were used as the second external additives, Example 14 is an example in which silica particles having large particle size and titanium oxide particles were used. It was found that, even in the case of Example 14, charge reduction and fogging can be suppressed when the image forming apparatus is operated for a long time.

The embodiments disclosed herein are illustrative in all respects and are not the basis for a limited interpretation. Accordingly, the technical scope of the disclosure is not to be construed by the foregoing embodiments only, and is defined based on the description of the claims. In addition, meanings equivalent to the range of the claims and all changes made within the range are included.

### REFERENCE SIGNS LIST

1 Toner particle
2 Large particle size external additive
3 Small particle size external additive
T Toner

1. A toner comprising toner particles and an external additive adhering to a surface of the toner particles, wherein
the toner particles include a crystalline polyester resin and a wax and have an apparent viscosity at 90° C. in a range from 100000 Pa*s to 200000 Pa*s,
the external additive includes a first external additive and a second external additive having an average primary particle size larger than that of the first external additive,
a loose bulk density of the toner is in a range from 0.3 g/cm³ to 0.35 g/cm³, and
when the toner is compressed at 50° C. and 1.2 N/cm², a compression degree of the toner is 50% or less, and a stress relaxation ratio of the toner is 27% or more.

2. The toner according to claim 1, wherein
the first external additive includes silica particles, titanium oxide particles, aluminum oxide particles, silica particles including aluminum hydroxide adhering to a surface of the silica particles, or strontium titanate particles to which silica is added, and
an average primary particle size of the first external additive is in a range from 10 nm to 35 nm.

3. The toner according to claim 1, wherein
the second external additive includes silica particles and titanium oxide particles, and
the silica particles and the titanium oxide particles serving as the second external additive have an average primary particle size in a range from 38 nm to 120 nm.

4. The toner according to claim 1, wherein
a content of the first external additive is in a range from 0.1 parts by mass to 0.5 parts by mass relative to 100 parts by mass of the toner particles, and
a content of the second external additive is in a range from 4.0 parts by mass to 6.0 parts by mass relative to 100 parts by mass of the toner particles.

5. The toner according to claim 1, wherein
a strength of adhesion of the first external additive to the toner particles is in a range from 90% to 100%, and
a strength of adhesion of the second external additive to the toner particles is in a range from 30% to 50%.

6. The toner according to claim 1, wherein
the toner particles are pulverized toner particles.

7. A two-component developer comprising the toner according to claim 1 and a carrier.

8. A method for producing the toner according to claim 1, the method comprising:
(a) mixing the first external additive and the toner particles to cause the first external additive to adhere to a surface of the toner particles; and
(b) mixing the second external additive and the toner particles to cause the second external additive to adhere to a surface of the toner particles, wherein
step (b) is performed after step (a).
